(19) United States
(12) Patent Application Publication
(10) Pub. No.: US 2016/0279950 A1
(43) Pub. Date: Sep. 29, 2016

(54) Image Forming Device

(71) Applicant: KONICA MINOLTA INC., Chiyoda-ku, Tokyo (JP)

(72) Inventors: Toyoaki SUGAYA, Hachioji-shi, Tokyo (JP); Mitsuru OBATA, Sagamihara-shi, Kanagawa (JP); Toshiyuki MIZUTANI, Hino-shi, Tokyo (JP); Takashi MURAMATSU, Hachioji-shi, Tokyo (JP)

(73) Assignee: KONICA MINOLTA INC., Chiyoda-ku, Tokyo (JP)

(21) Appl. No.: 14/901,446

(22) PCT Filed: Jun. 25, 2014
(86) PCT No.: PCT/JP2014/066811

§ 371 Date: Dec. 28, 2015

(30) Foreign Application Priority Data
Jun. 28, 2013 (JP) 2013-136665

(51) Int. Cl. B41J 2/165

(52) U.S. Cl. CPC B41J 2/16517

(57) ABSTRACT

An image forming device includes an image forming section which includes a recording head having nozzles and which forms an image on a recording medium by discharging ink from the nozzles, a scanning section which scans the image formed on one face of the recording medium, a conveying section which conveys the recording medium for the recording medium to pass by the image forming section and the scanning section with its one face facing them, and an inverting section which inverts the recording medium having the image formed on one face thereof and conveys the recording medium to the upstream of the image forming section. The scanning section is disposed downstream of the image forming section and upstream of the inverting section. The image includes a test chart as a pattern image for detection of nozzle clogging.

### TECHNICAL FIELD

The present invention relates to an image forming device.

### BACKGROUND ART

An image forming device including a scanning section which, before a recording medium is ejected, optically scans an image formed on the recording medium is known (see, for example, Patent Literatures 1 and 2). Such an image forming device has a function to scan an image formed on a recording medium using the scanning section, and to make various determinations, such as the determinations of whether the formed image is good or bad and whether a recording medium has a pre-existing image.

In order to allow image formation on both faces of recording media, the above described image forming device includes an individual scanning section for each face.

### PRIOR ART LITERATURES

### Patent Literatures

Patent Literature 1: Japanese Unexamined Patent Application Publication No. 2009-25374
Patent Literature 2: Japanese Unexamined Patent Application Publication No. 2009-169105

### DISCLOSURE OF INVENTION

### Problems to be Solved by the Invention

Unfortunately, providing an individual scanning section for each face of recording media leads to increase in cost of the image forming device. Further, both of the scanning sections for scanning both faces are not exploited at the time of image formation on one face of a recording medium where the scanning section for a non-image-formation face does not operate.

Further, with the method where images are formed on both faces successively and then the images on both faces are scanned for determinations to be made, abnormalities in the image formed on the first face, if any, cannot be detected until after the image formation on both faces. This leads to wasteful image formation and wasteful use of materials and time.

An object of the present invention is to provide an image forming device that can perform both-face scanning at low cost without waste.

### Means for Solving Problems

An image forming device according to the invention recited in claim 1 is an image forming device including: an image forming section which forms an image on a recording medium; a scanning section which scans the image formed on one face of the recording medium by the image forming section; a conveying section which conveys the recording medium in such a way that the recording medium passes by locations of the image forming section and the scanning section with one face of the recording medium facing the image forming section and the scanning section; and an inverting section which, if the image is to be formed on each face of the recording medium by the image forming section, inverts the recording medium having the image formed on one face thereof and conveys the recording medium to an upstream of the image forming section in a conveyance direction of the conveying section, wherein the scanning section is disposed downstream of the image forming section and upstream of the inverting section in the conveyance direction.

The invention recited in claim 2 is the image forming device according to claim 1, further including a changing section which changes a condition relating to image formation by the image forming section based on a result of scanning by the scanning section.

The invention recited in claim 3 is the image forming device according to claim 2, wherein the image forming section includes a recording head having nozzles from which ink is to be discharged, and the condition includes a condition relating to ink discharge from the nozzles.

The invention recited in claim 4 is the image forming device according to claim 2 or 3, wherein the condition includes a content relating to brightness of the image.

The invention recited in claim 5 is the image forming device according to any one of claims 2 to 4, further including a comparing section which compares image data, based on which the image is to be formed by the image forming section, with scanning data created by the scanning section's scanning the image formed by the image forming section based on the image data, wherein the changing section changes the condition based on a result of comparison by the comparing section.

The invention recited in claim 6 is the image forming device according to any one of claims 1 to 5, further including a fixing section which fixes the image formed by the image forming section on the recording medium, wherein the scanning section is disposed downstream of the fixing section.

The invention recited in claim 7 is the image forming device according to any one of claims 1 to 6, further including: a setting section which makes a setting as to whether the image is to be formed on one face or each face of the recording medium by the image forming section; and a display section which performs display relating to the setting made by the setting section.

The invention recited in claim 8 is the image forming device according to any one of claims 1 to 7, further including a control section which controls conveyance of the recording medium based on a result of scanning by the scanning section.

The invention recited in claim 9 is the image forming device according to any one of claims 1 to 8, wherein the scanning section is disposed on one side of a conveyance path on which the recording medium is to be conveyed by the conveying section; and after the scanning section scans, from the one side, the image formed on one face of the recording medium, the inverting section inverts and conveys the recording medium, the image forming section forms an image on the other face of the recording medium, and the scanning section scans, from the one side, the image formed on the other face.

### Effects of the Invention

The present invention allows both-face scanning at low cost without waste.

### BRIEF DESCRIPTION OF DRAWINGS

FIG. 1 shows the main configuration of an image forming system according to an embodiment of the present invention.

FIG. 2 is a block diagram showing the main configuration of the image forming system.

FIG. 3A shows an example change in condition relating to ink discharge from the nozzles, and an example state of discharged ink with a missing part.

FIG. 3B shows an example change in condition relating to ink discharge from the nozzles, and an example state of discharged ink after the condition is changed to cover the missing part.

FIG. 4 shows an example concrete configuration of an irradiating section.

FIG. 5 shows example correspondence relation between the light wavelength emitted by the light source of the irradiating section, the total amount of light required for curing four-color ink, and the luminous intensity of the light emitted by the light source.

FIG. 6 shows example spectral sensitivity characteristics of a CCD image sensor of a scanning section.

FIG. 7A shows an example positional relationship between a drum, an image forming section, the irradiating section, and the scanning section, and is a drawing relating to the explanations of a predetermined irradiation area and a slowdown area.

FIG. 7B shows an example positional relationship between the drum, the image forming section, the irradiating section, and the scanning section, and is a drawing relating to the explanations of the distance between the intersection of the center line and the outer periphery surface of the drum and the scanning position of the scanning section.

FIG. 8A shows, for the case in which shields are provided, a graph representing the relationship between the position of the scanning section relative to the center line and the intensity of the ultraviolet rays that enter the CCD image sensor at the time of scanning by the scanning section.

FIG. 8B shows, for the case in which shields are not provided, a graph representing the relationship between the position of the scanning section relative to the center line and the intensity of the ultraviolet rays that enter the CCD image sensor at the time of scanning by the scanning section.

FIG. 9 shows an example test chart.

FIG. 10 shows an example positional relationship adjustment image.

FIG. 11 shows example positions at which pattern images are formed.

FIG. 12 shows example creation of composite image data.

FIG. 13 shows example shading images.

FIG. 14 shows a case in which formation of a pattern image has been completed before the downstream end, of the ends in the conveyance direction, of the pattern image formed on the recording medium reaches the scanning position of the scanning section.

FIG. 15 shows a case in which the formation positions of pattern images on both faces do not coincide with each other.

FIG. 16 shows example composite image data with a blank part.

FIG. 17 is a block diagram showing the main configuration of an image forming system further including a comparing section.

### EMBODIMENT TO CARRY OUT THE INVENTION

An embodiment of the present invention will now be described below with reference to the drawings. The embodiment includes various limitations that are technically preferable to carry out the invention. The scope of the invention, however, is not limited to the embodiment described below and the examples shown in the drawings.

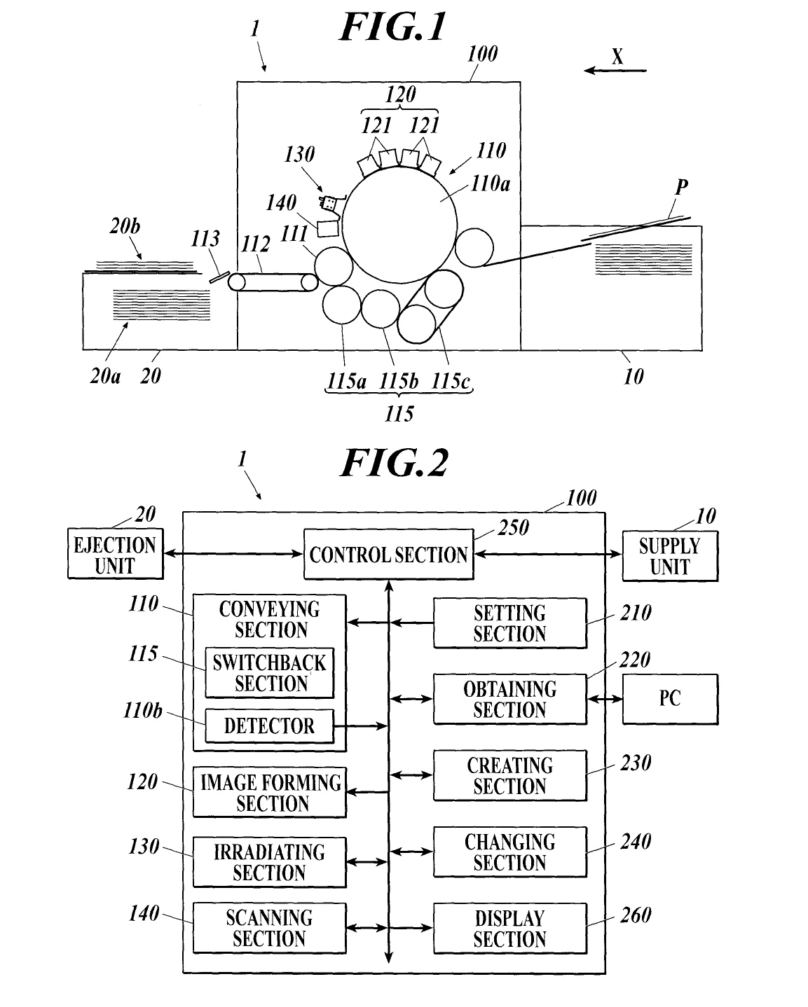

FIG. 1 shows the main configuration of an image forming system 1 including an image forming device according to an embodiment of the present invention.

The image forming system 1 includes a supply unit 10, a main body unit 100, and an ejection unit 20. The supply unit 10, the main body unit 100, and the ejection unit 20 are disposed along a predetermined direction (the X direction in FIG. 1) and are connected with each other.

The supply unit 10 contains recording media P (e.g. sheets of paper), on which images are to be formed by an image forming section 120 included in the main body unit 100. The supply unit 10 supplies the recording media P one by one to the main body unit 100.

The main body unit 100 forms an image on a recording medium P supplied from the supply unit 10 and ejects the recording medium P, on which the image has been formed, to the ejection unit 20.

The main body unit 100 includes, for example, a conveying section 110 which conveys a recording medium P, the image forming section 120 which forms an image on the recording medium P, an irradiating section 130 which irradiates, with energy, the recording medium P on which the image has been formed by the image forming section 120, and a scanning section 140 which scans the medium which is being conveyed by the conveying section 110. The main body unit 100 serves as an image forming device in the image forming system 1.

The conveying section 110 conveys the medium to the image forming section 120, the irradiating section 130, and the scanning section 140.

Specifically, the conveying section 110 includes, for example, a cylindrical drum 110a. The drum 110a is rotatable about an axis passing through the center of the cylinder and has a cylindrical outer periphery surface to support a recording medium P thereon. The conveying section 110 conveys a recording medium P by rotating the drum 110a while one face of the recording medium P supported by the outer periphery surface is facing the image forming section 120, the irradiating section 130, and the scanning section 140.

The image forming section 120, the irradiating section 130, and the scanning section 140 are disposed along the outer periphery surface of the drum 110a close to where the outer periphery surface of the rotating drum 110a passes. Specifically, as shown in FIG. 1, the image forming section 120, the irradiating section 130, and the scanning section 140 are disposed in this order from the upstream side to the downstream side along a conveyance path on which the recording media P supplied from the supply unit 10 are to be conveyed toward the ejection unit 20, among the conveyance paths on which the recording media P are to be conveyed with the movement of the outer periphery surface of the drum 110a.

The conveying section 110 includes a detector 110b to detect the angle of rotation of the drum 110a. The conveying section 110 can detect, based on the angle of rotation of the drum 110a detected by the detector 110b, the position of a recording medium P supported by the outer periphery surface of the drum 110a and conveyed thereon. The detector 110b is, for example, but not limited to, an encoder disposed on the rotating shaft of the drum 110a. The detector 110b may have any other configuration that can detect the angle of rotation of the drum 110a.

The conveying section 110 includes a mechanism to invert recording media P.

Specifically the conveying section 110 includes, for example, a switchback section 115. The switchback section 115 inverts a recording medium P with switchback and conveys the recording medium P.

More specifically, the switchback section 115 is composed of, for example, two cylinders (a first cylinder 115a and a second cylinder 115b) and a belt loop (belt loop 115c) as shown in FIG. 1.

A recording medium P is delivered from the drum 110a through a cylinder 111 rotating in the clockwise direction in FIG. 1 to the first cylinder 115a rotating in the counterclockwise direction in FIG. 1. The recording medium P is then delivered to the second cylinder 115b rotating in the clockwise direction in FIG. 1. When the rear edge of the recording medium P reaches the vicinity of the nip part between the second cylinder 115b and the belt loop 115c that is rotating in the counterclockwise direction in FIG. 1, the belt loop 115c changes in rotation direction to the clockwise direction in FIG. 1 and conveys the recording medium P to the drum 110a with the recording medium P sticking to the belt loop 115c. The recording medium P is brought back to the drum 110a by the belt loop 115c, so that the recording medium P is on the drum 110a again with the face, on which an image has been formed, of the recording medium P being in contact with the outer periphery surface of the drum 110a. That is, the recording medium P is turned over by the switchback section 115. The head end in the conveyance direction of the recording medium P that has been returned to the drum 110a corresponds to the tail end of when the recording medium P was conveyed by the drum 110a before being returned to the drum 110a. That is, the switchback section 115 conveys the recording medium P in such a way as to invert the recording medium P, causing the recording medium P to be turned upside down.

In this way, the conveying section 110 inverts a medium, such as a recording medium P, with the switchback section 115 while conveying the recording medium P and thereby allows both faces of the recording medium P to sequentially face the image forming section 120 while conveying the recording medium P.

The position at which the first cylinder 115a of the switchback section 115 receives a recording medium P from the drum 110a is downstream of the irradiating section 130 in the recording medium P conveyance direction. The belt loop 115c returns the recording medium P to the drum 110a, and then the returned recording medium P is conveyed to the image forming section 120 again from the upstream of the image forming section 120.

In this way, the switchback section 115 serves as an inverting section which, if both-face image formation is to be performed on a recording medium P by the image forming section 120, inverts the recording medium P having an image formed on one face thereof and conveys the recording medium P to the upstream of the image forming section 120 in the conveyance direction of the conveying section 110.

The scanning section 140 is disposed downstream of the image forming section 120 and upstream of the switchback section 115 in the conveyance direction. Accordingly, the switchback section 115 serves as a reconveying section to convey the recording medium P, which has been conveyed by the conveying section 110 through the image forming section 120 and the scanning section 140, to the upstream of the scanning section 140 in the conveyance direction of the conveying section 110 and to allow the conveying section 110 to convey the recording medium P again.

The image forming section 120 forms an image on a recording medium P.

Specifically, the image forming section 120 includes head units 121 having a plurality of recording heads H with nozzles to discharge ink onto a recording medium P supported by the drum 110a. The head units 121 are provided for the respective colors of the ink to be discharged onto a recording medium P (i.e., four colors of cyan (C), magenta (M), yellow (Y), and black (K)). The image forming section 120 having such head units 121 discharges ink to form an image on a recording medium P.

The irradiating section 130 emits energy to fix an image on a recording medium P on which the image has been formed by the image forming section 120.

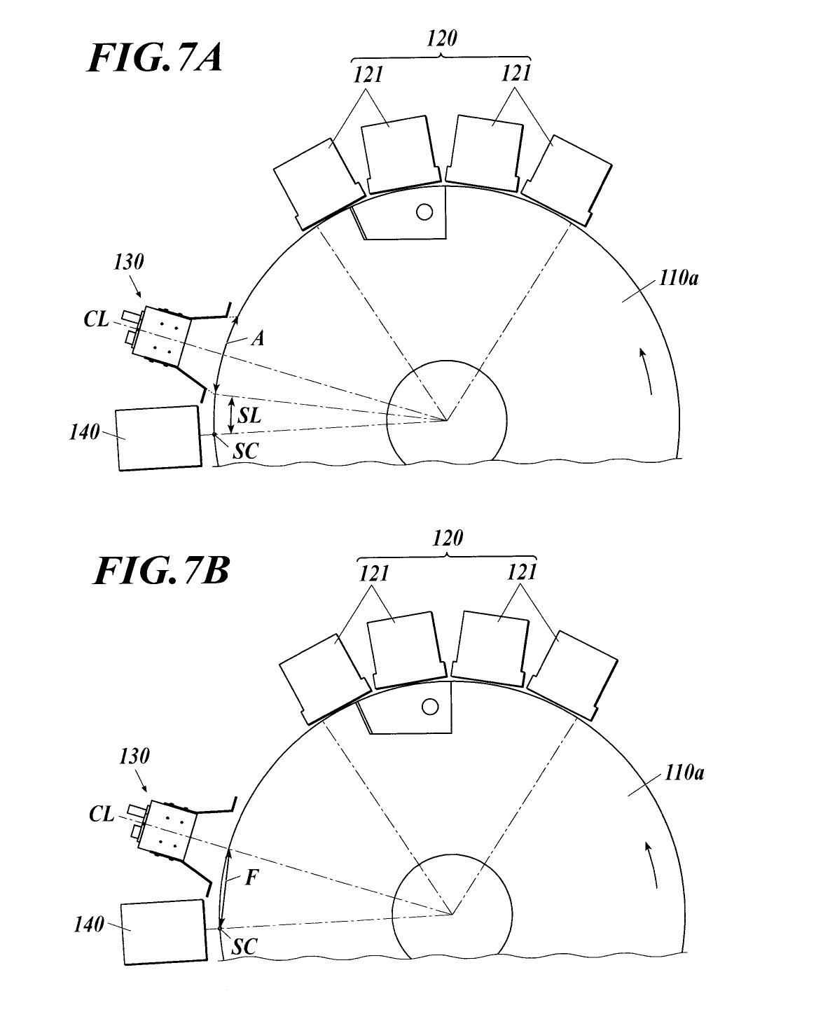

The energy to be emitted by the irradiating section 130 depends on the characteristics of the ink. If, for example, ultraviolet curable ink, which is cured by being irradiated with ultraviolet rays, is used for the head units 121 of the image forming section 120, the energy to be emitted by the irradiating section 130 is ultraviolet rays. In this case, the irradiating section 130 includes a light source 131, such as a light emitting diode (LED) to emit ultraviolet rays (UV), and shields 132 which confine the range (irradiation range), which is irradiated with the ultraviolet rays emitted by the light source 131, to a predetermined irradiation area A (see FIG. 7A). The predetermined irradiation area A is an area in the path through which a recording medium P passes while being supported by the outer periphery surface of the drum 110a of the conveying section 110. The irradiating section 130 emits ultraviolet rays to a recording medium P which is being conveyed by the conveying section 110 and passing through the predetermined irradiation area A.

When the irradiating section 130 emits energy, the ink which has been discharged onto the recording surface of a recording medium P is cured and fixed on the recording surface. In this way, the irradiating section 130 serves as a fixing section to fix an image formed by the image forming section 120 on a recording medium P.

The scanning section 140 scans a medium that is being conveyed by the conveying section 110.

Specifically, the scanning section 140 includes an imaging device, such as a charge-coupled device (CCD) image sensor, an illuminator to illuminate a recording medium P, and a lens disposed on the line of fire between the imaging device and a recording medium P. The imaging device detects the light reflected from an illuminated recording medium P and outputs electrical signals according to the results of the detection. The data according to the result of the scanning is generated based on the electrical signals output from the imaging device of the scanning section 140 and is processed as the scanning result.

The ejection unit 20 allows the recording media P, which have been ejected from the drum 110a of the main body unit 100 through the cylinder 111, a belt loop 112, and an ejection switching guide 113, to stand by until being collected by a user. Whether a recording medium P is to be ejected to the ejection unit 20 or to be conveyed to the switchback section 115 through the cylinder 111 is controlled by a control section 250.

The image forming system 1 may include a conveyance path to allow correction media, which are for various types of correction, to pass in the main body unit 100.

Specifically, for example, the supply unit 10 may include a supply tray to supply the correction media provided separately from a tray that stores the recording media P as shown in FIG. 1. The ejection unit 20 may include a sub tray 20b to which the correction media are to be ejected, which sub tray 20b is provided separately from a main tray 20a where the recording media P standby. The control section 250 controls the ejection switching guide 113 to switch the destinations of ejection of recording media P between the main tray 20a and the sub tray 20b.

In this way, the image forming system 1 conveys some types of media (e.g. the correction media) including the recording media P and the scanning section 140 can scan the media.

Each of the media may be of any type as long as it is a sheet having such a size that the conveying section 110 can convey it. Among the dimensions of the medium, the dimension in the conveyance direction is, for example, in accordance with the circumferential length of the drum 110a. Among the dimensions of the medium, the dimension in the width direction perpendicular to the conveyance direction is, for example, in accordance with the width of the outer periphery surface of the drum 110a (i.e., the width of the drum 110a in the direction in which the center axis of the cylinder extends).

FIG. 2 is a block diagram showing the main configuration of the image forming system 1.

The main body unit 100 of the image forming system 1 includes, for example, a setting section 210, an obtaining section 220, a creating section 230, a changing section 240, a control section 250, and a display section 260.

The setting section 210 includes input devices, such as buttons, keys, and a touch panel, to be used for input of various settings relating to the operations of the image forming system 1. The setting section 210 outputs, to the control section 250, signals corresponding to the settings that have been made in response to user operations on the input devices.

Specifically, for example, the setting section 210 outputs, to the control section 250, a signal for a setting, according to a user operation, as to whether image formation is to be performed on one face or on each face of a recording medium P by the image forming section 120.

The obtaining section 220 obtains original data based on which an image is to be formed by the image forming section 120.

Specifically, the obtaining section 220 includes a component for communication, such as a network interface card (NIC) to obtain a print job sent from an external device, such as a PC, connected through the communication. The print job includes the image data corresponding to an image to be formed by the image forming section 120.

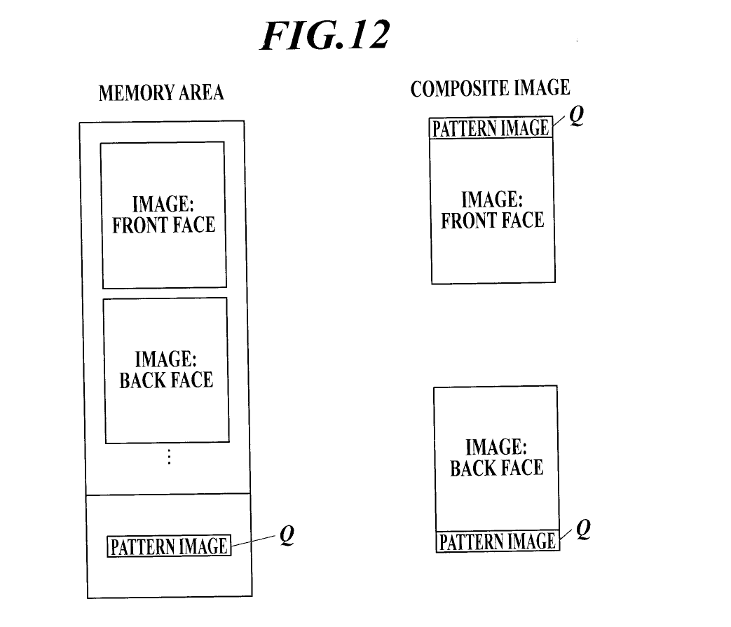

The creating section 230 creates composite image data in which an image (e.g. the image corresponding to the image data included in a print job) and a pattern image Q to be formed on a recording medium P along with the image are combined with each other (see FIG. 12). The pattern image Q is formed on a margin of a recording medium P on which the image is formed. The pattern image Q is used for adjustment of the image forming section 120.

Specifically, for example, the creating section 230 is composed of an integrated circuit, such as a programmable logic device (PLD, e.g., a field-programmable gate array (FPGA)), an application-specific integrated circuit (ASIC), or a circuit made of a combination thereof. The creating section 230 includes a processor and a storage device (memory) fitted in the circuit. The creating section 230 stores, in the memory, the image data included in a print job and the image data corresponding to a pattern image Q stored in advance, and creates the composite image data through the operation of the processor.

The changing section 240 changes a condition relating to image formation by the image forming section 120 based on the result of scanning by the scanning section 140.

Specifically, for example, the changing section 240 is composed of an integrated circuit, such as a PLD or an ASIC or a combination thereof. The changing section 240 performs processes for the condition relating to image formation through the collaboration between a processor and a storage device fitted in the circuit.

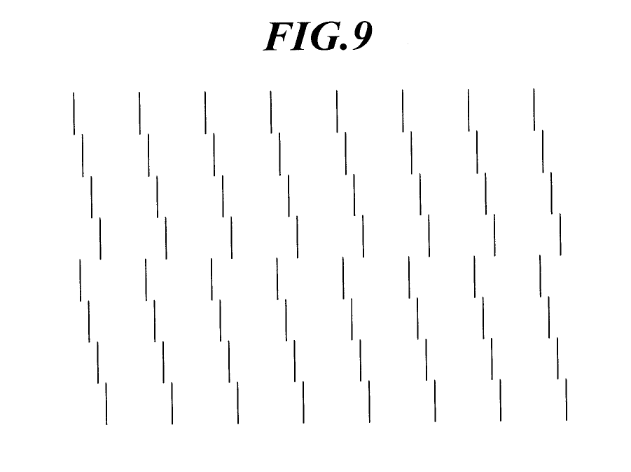

For example, if clogging is detected at any of the nozzles of the recording heads H of the head units 121 based on the result of scanning of a test chart (see FIG. 9) by the scanning section 140, the condition relating to ink discharge from the nozzles, in the condition relating to image formation, is changed to a condition taking into account the fact that ink is not discharged from the nozzles having the clogging.

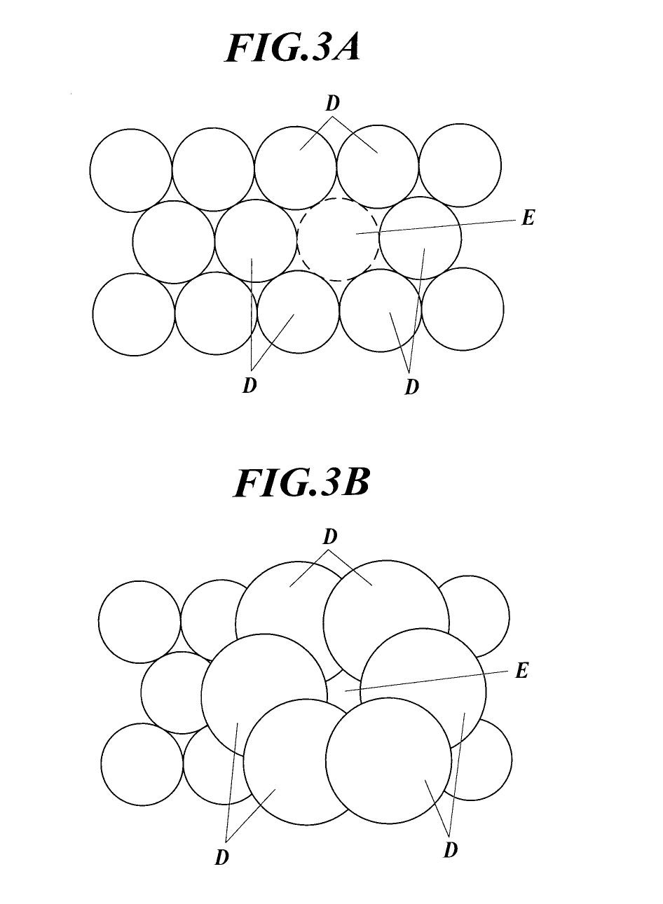

Specifically, for example, the changing section 240 changes the condition relating to ink discharge from the nozzles in such a way that a missing part E is covered by the ink of the dots D discharged onto the neighborhood of the missing part E, the missing part E being a part onto which no ink is discharged due to the clogging of a nozzle, as shown in FIGS. 3A and 3B. More specifically, the missing part E is covered as shown in FIG. 3B by increasing the amount of ink of the dots D to be discharged onto the neighborhood of the missing part E of FIG. 3A. This can reduce the influence of the missing part E on the image quality.

As noted above, the condition relating to image formation to be changed by the changing section 240 includes the condition relating to ink discharge from the nozzles.

Examples of changes in condition to cover the missing part E with the ink discharged onto the neighborhood of the missing part E include a change in driving signals for the nozzles to discharge the ink onto the neighborhood of the missing part E.

Another example is a change in condition by correcting color values of the pixels corresponding to the missing part E and the pixels neighboring the pixels in the original image data based on which the nozzle-driving conditions are to be determined. In this case, the correction of the color values to increase the amount of ink to be discharged can cover the missing part E.

The control section 250 controls the operations of the components of the image forming system 1.

Specifically, the control section 250 includes, for example, a CPU, a RAM, and a ROM.

The CPU reads out various types of programs and data etc. from a storage device, such as the ROM, in accordance with the processing details and executes them. The CPU controls the operations of the components of the image forming system 1 in accordance with the executed processing details. The RAM temporarily stores various types of programs and data etc. processed by the CPU. The ROM. stores various types of programs and data etc. read out by the CPU etc.

The display section 260 performs various types of displays relating to the operations of the image forming system 1 under the control of the control section 250.

Specifically, for example, the display section 260 includes a display device, such as a liquid crystal display integrated with a touch-panel input device. The display section 260 performs various types of displays with the display device. The display device is not limited to such a liquid crystal display, which is merely an example, but maybe another display device, such as an organic electroluminescence (EL) display.

The display section 260 performs display relating to a setting made by the setting section 210, for example. Specifically, the display section 260 displays a screen to allow a selection of a face on which image formation is to be performed (i.e., one face or each face), in connection with a setting as to whether the image formation is to be performed on one face or each face of a recording medium P by the image forming section 120. When a user performs an operation on the setting section 210 for the selection of one face or each face in accordance with the display, the setting section 210 outputs, to the control section 250, a signal for making a setting as to whether the image formation is to be performed on one face or each face of a recording medium P by the image forming section 120.

The detailed features of the image forming system 1 are described below step by step.

First, explanations are given over the conveyance by the conveying section 110 and the operation of the scanning section 140 in the case in which the scanning section 140 scans each face of a medium.

A medium is supported by the drum 110a with its one face (front face) facing the scanning section 140 and is conveyed from the upstream of the scanning section 140 to the downstream of the scanning section 140 in the medium conveyance direction. With this conveyance, the scanning section 140 scans one face of the medium passing through the scanning position SC (see FIG. 7A).

The medium that has been conveyed to the downstream of the scanning section 140 is conveyed by the switchback section 115 with a switchback. This allows the medium to be supported by the drum 110a with the other face (back face) thereof facing the scanning section 140 and allows the medium to be located at the upstream of the scanning section 140 again. The medium is then conveyed from the upstream of the scanning section 140 to the downstream of the scanning section 140 in the medium conveyance direction again. With this conveyance, the scanning section 140 scans the other face of the medium passing through the scanning position SC.

In this way, the scanning section 140, which is arranged to scan one face of a medium, can scan both faces of a medium.

Next, the irradiating section 130 will be described in detail.

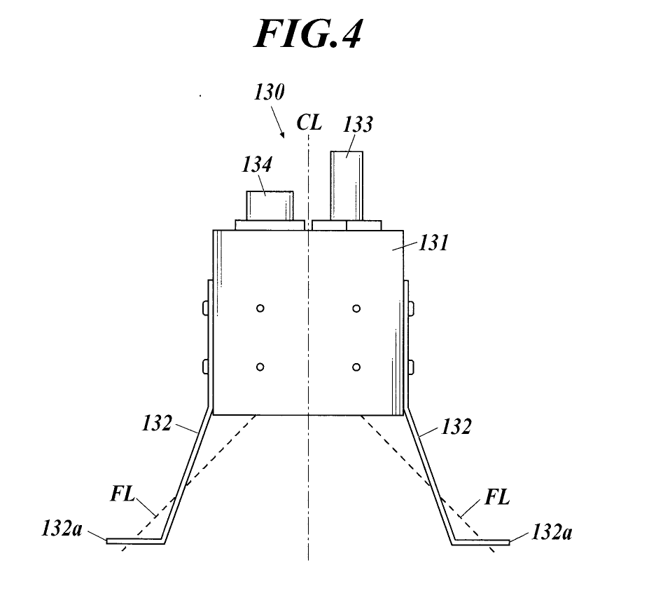

FIG. 4 shows an example of a specific configuration of the irradiating section 130.

The irradiating section 130 includes a connector 133 to be connected to an electrical power line to supply power to the light source 131 and a water-cooling opening 134 to supply cooling water to cool the light source 131, in addition to the light source 131 and the shields 132 mentioned above.

The shields 132 extend, for example, from the sides of the case of the light source 131 toward the outer periphery surface of the drum 110a of the conveying section 110. The shields 132 extends in such a way as to form a predetermined angle spread from the light source 131 toward the outer periphery surface of the drum 110a with respect to the direction in which a recording medium P is conveyed by the drum 110a of the conveying section 110.

Specifically, each of the shields 132 is disposed at an angle of 19.4° to the center line CL connecting the center of the generation area where the light is emitted by the light source 131 and the center of rotation of the drum 110a. The shields 132 of this embodiment are made of aluminum plates that are designed to reflect 98% of the ultraviolet rays emitted by the light source 131 inside of the lampshade that spreads toward the end. The particularities relating to the concrete configurations of the shields 132 are merely examples and are not limitative. The concrete details in design, such as the predetermined angle, the material, and the reflectivity, can be modified as appropriate.

Without the shields 132, the irradiation angle FL, in the direction in which a recording medium P is conveyed by the drum 110a of the conveying section 110, of the ultraviolet rays emitted by the light source 131 would spread from the light source 131 toward the drum 110a at an angle of larger than 19.4° to the center line CL as shown in FIG. 4. The shields 132 extending from the light source 131 can block the ultraviolet rays and prevent a part of the ultraviolet rays from irradiating an unintended location (for example, the scanning position SC at which the scanning section 140 scans a recording medium P) with respect to the direction in which a recording medium P is conveyed by the drum 110a of the conveying section 110. The shields 132 confine the range, which is irradiated with the ultraviolet rays (i.e., irradiation range), to the predetermined irradiation area A.

In this way, the shields 132 block a part of energy from the irradiating section 130 between the irradiating section 130 and the scanning section 140.

The end part, adjacent to the drum 110a, of each of the shields 132 may have an extension part 132a extending substantially along the outer periphery surface of the drum 110a as shown in FIG. 4.

Each extension part 132a is designed in such a way that the surface, adjacent to the drum 110a, of the extension part 132a does not easily reflect the light (e.g. ultraviolet rays) from the light source 131. Specifically, for example, an antireflection member is put on the surface, adjacent to the drum 110a, of each extension part 132a. Each extension part 132a thereby reduces the light reflection between the extension part 132a and a recording medium P supported by the drum 110a and thus reduces the intensity of the light guided in the direction away from the center line CL.

The relation between the light (ultraviolet rays), which is energy emitted by the irradiating section 130, and the curing characteristics of the ink used for the image forming section 120 in this embodiment will now be described.

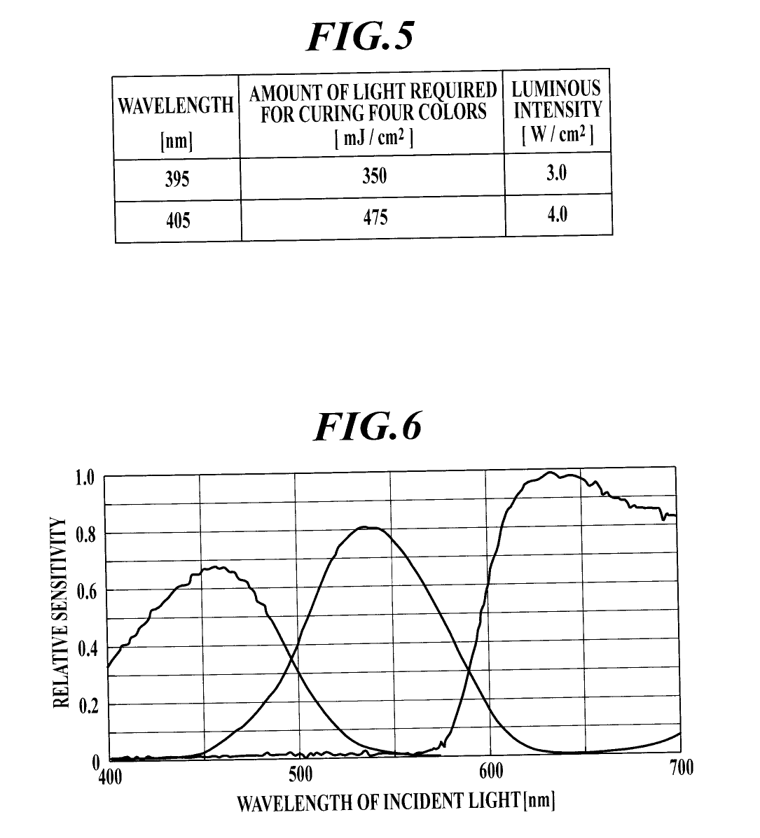

FIG. 5 shows example correspondence relation between the wavelength of the light emitted by the light source 131 of the irradiating section 130, the total amount of light required to cure the four-color ink, and the luminous intensity of the light emitted by the light source 131. FIG. 5 also shows an example numerical value condition relating to the level of irradiation with ultraviolet rays in this embodiment.

In order to surely cure the four-color ink that has been discharged for image formation onto a recording medium P supported and conveyed by the drum 110a, the recording medium P needs to be irradiated with the ultraviolet rays corresponding to the total amount of light shown in FIG. 5 in accordance with the light wavelength while the recording medium P is passing the predetermined irradiation area A, which is and area irradiated with the light (ultraviolet rays) by the irradiating section 130. For example, the total amount of light required for a light wavelength of 395 nm is 350 mJ/cm². The total amount of light required for a light wavelength of 405 nm is 475 mJ/cm². Generally speaking, a smaller total amount of light is required when the wavelength is shorter.

The intensity of the ultraviolet rays (e.g. wavelength and luminous intensity of light) to be emitted by the irradiating section 130 is set based on the conditions described above. For example, if the conveyance speed of a recording medium P supported and conveyed by the drum 110a is 850 mm/s and the length of the predetermined irradiation area A in the direction in which the recording medium P is conveyed by the drum. 110a is 68 mm, a setting is made so that the correspondence relation between the light wavelength and the luminous intensity shown in FIG. 5 is satisfied. Specifically, for example, if the light emitted by the light source 131 has a wavelength of 395 nm, the luminous intensity is set to 3.0 W/cm². If the light emitted by the light source 131 has a wavelength of 405 nm, the luminous intensity is set to 4.0 W/cm². The luminous intensities of light shown in FIG. 5 are the measurement results obtained by measurements with an illuminometer for exclusive use at a distance of 10 mm from the source of light generation of the light source 131. The operation conditions of the light source 131 are set in such a way that such measurement results can be obtained.

The relation between the ultraviolet rays, which are energy to be emitted by the irradiating section 130 in this embodiment, and the detection of light relating to the scanning by the scanning section 140 will now be described.

FIG. 6 shows example spectral sensitivity characteristics of a CCD image sensor of the scanning section 140.

As shown in FIG. 6, the CCD image sensor has sensitivity to light whose wavelength is 400 nm to 700 nm. Accordingly, if the light emitted by the light source 131 of the irradiating section 130 has a wavelength of, for example, 405 nm, the CCD image sensor has sensitivity to the light emitted by the light source 131 of the irradiating section 130 and the reflected light thereof.

Although not shown in FIG. 6, the CCD image sensor is not non-sensitive to all the lights having a wavelength of less than 400 nm, such as 395 nm. The light wavelength set for the light source 131 is a center wavelength, and the light actually emitted by the light source 131 does not have a perfect single wavelength. For this reason, the CCD image sensor may show sensitivity to the light emitted by the light source 131 of the irradiating section 130 and the reflected light thereof when the wavelength of the light to be emitted by the light source 131 of the irradiating section 130 is set to less than 400 nm.

If the light emitted by the irradiating section 130 enters the CCD image sensor during the scanning operation by the scanning section 140 and the light that has entered the CCD image sensor has a predetermined intensity or more, the light may have an influence on the result of detection by the CCD image sensor. Specifically, for example, in the case in which ultraviolet rays are emitted from the irradiating section 130 as in this embodiment, the light emitted by the irradiating section 130 and entering the CCD image sensor during the scanning operation by the scanning section 140 may alter the detection results relating to violet and/or blue light, which is detected with the light having a wavelength close to that of ultraviolet rays.

The distance that the light from the light source 131 travels also varies depending on whether a recording medium P to be irradiated with the light is a processed medium or not.

For example, a glossy process is known as one of the processing treatments for recording media P. Paper that has been subjected to the glossy process is called glossy paper. The glossy paper having much gloss (high-gloss paper) reflects light, which has been emitted to the recording surface, in a specific direction more intensely than less glossy paper. If high-gloss paper is used as a recording medium P, the light from the irradiating section 130 is reflected by the recording medium P more intensely and there is a relatively high possibility that the light reaches other components (e.g. the scanning section 140).

For the purpose of making the recording surface of a recording medium P even whiter, a fluorescent whitening agent may be used. A recording surface that has been made whiter by the fluorescent whitening agent reflects light more intensely. So, if the fluorescent whitening agent is applied to a recording medium P, the light from the irradiating section 130 is reflected by the recording medium P intensely and there is a relatively high possibility that the light reaches other components (e.g. the scanning section 140).

In light of the above, in order to maintain the accuracy of scanning by the scanning section 140, the irradiating section 130 and the scanning section 140 should be disposed in such a way that the energy (e.g. ultraviolet light) emitted by the irradiating section 130 does not have an influence on the image scanning by the scanning section 140. So, the relative positions of the irradiating section 130 and the scanning section 140 are such that the irradiation range on a recording medium P, which is irradiated with energy by the irradiating section 130, does not overlap the scanning position SC at which the scanning section 140 scans the recording medium P. Further, the relative positions of the irradiating section 130 and the scanning section 140 in this embodiment are such that the intensity of light which is emitted by the irradiating section 130 and which enters the scanning position SC to be involved in the image scanning by the scanning section 140 is equal to or less than the intensity of light required for the detection of differences in gradation of the image to be scanned by the scanning section 140 (e.g. 0.4%).

In connection with the relative positions of the irradiating section 130 and the scanning section 140, explanations will now be given to a case in which the CCD image sensor can distinguish eight bits, i.e., 256 gradations indicated by numerical values of 0 to 255, for each of red (R), green (G), and blue (B).

The eight-bit CCD image sensor distinguishes a maximum of 256 gradations as a result of detection according to the intensity of light of each color. Suppose the intensity of when no light is detected (detection result: 0) is defined as 0% and the intensity of when the strongest light is detected (detection result: 255) is defined as 100%. In this case, the difference in light intensity that creates one-gradation difference in a detection result is about 0.4% (0.392 . . . %). So, in the case of a scanning section 140 having an eight-bit CCD image sensor, the light emitted by the irradiating section 130 substantially does not have an influence on the image scanning by the scanning section 140 if the intensity of light which is emitted by the irradiating section 130 and which enters the scanning section 140 to be involved in the image scanning by the scanning section 140 is 0.4% or less of the intensity of the light to be used for the scanning by the scanning section 140 (for example, the light that is emitted by the illuminator, is reflected by a recording medium P, and then reaches the CCD image sensor). In other words, in the case of an eight-bit CCD image sensor, the light intensity required for the detection of the differences in gradation of an image to be scanned by the scanning section 140 is an intensity exceeding 0.4% of the intensity of the light to be used for the scanning by the scanning section 140.

Similarly, in the case of a ten-bit CCD image sensor, an acceptable intensity of light that is emitted by the irradiating section 130 and that enters the scanning section 140 to be involved in the image scanning by the scanning section 140 is 0.1% (0.0976 . . . %) or less of the intensity of the light to be used for the scanning by the scanning section 140. In the case of a twelve-bit CCD image sensor, an acceptable intensity of light that is emitted by the irradiating section 130 and that enters the scanning section 140 to be involved in the image scanning by the scanning section 140 is 0.02% (0.024 . . . %) or less of the intensity of the light to be used for the scanning by the scanning section 140.

In view of the above, in the image forming system 1 of this embodiment, the relative positions of the irradiating section 130 and the scanning section 140 are such that the irradiation range on a recording medium P, which is irradiated with energy by the irradiating section 130, does not overlap the scanning position SC at which the scanning section 140 scans the recording medium P. The energy emitted by the irradiating section 130 thus does not have an influence on the image scanning by the scanning section 140. Specifically, in the image forming system 1 in this embodiment, the relative positions of the irradiating section 130 and the scanning section 140 are such that the intensity of the light that is emitted by the irradiating section 130 and that possibly enters the scanning section 140 having an eight-bit CCD image sensor is 0.4% or less of the intensity of the light to be used for the scanning by the scanning section 140 (i.e., the light from the illuminator).

FIGS. 7A and 7B show an example positional relationship between the drum 110a, the image forming section 120, the irradiating section 130, and the scanning section 140. FIG. 7A is a drawing relating to the explanations of a predetermined irradiation area A and a slowdown area SL. FIG. 7B is a drawing relating to the explanations of the distance F between the intersection of the center line CL and the outer periphery surface of the drum 110a and the scanning position SC of the scanning section 140.

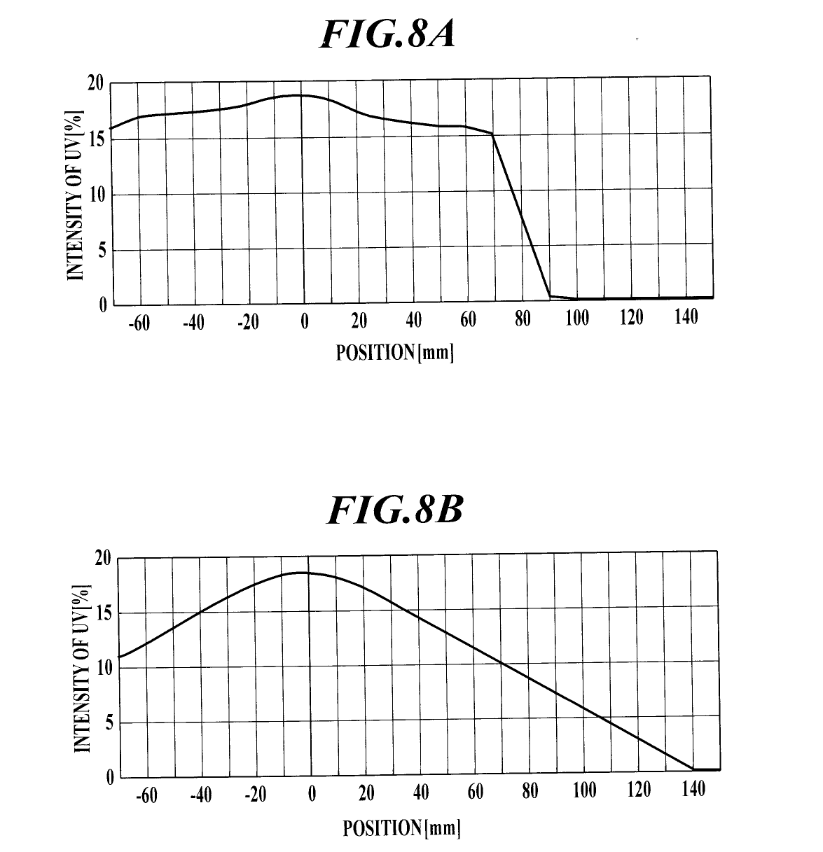

FIGS. 8A and 8B each show a graph representing the relationship between the position of the scanning section 140 relative to the center line CL and the intensity of the ultraviolet rays that enter the CCD image sensor at the time of scanning by the scanning section 140. FIG. 8A is a graph for the case in which the shields 132 are provided. FIG. 8B is a graph for the case in which the shields 132 are not provided. The absolute values on the horizontal axis in FIGS. 8A and 8B correspond to the distances F.

With the shields 132 as shown in FIG. 8A, a distance F of 70 mm or more remarkably reduces the intensity of the ultraviolet rays that enter the CCD image sensor at the time of the scanning by the scanning section 140 compared to a distance F of less than 70 mm. With the shields 132, a distance F of more than 100 mm can reduce, to substantially 0%, the intensity of the ultraviolet rays that enter the CCD image sensor at the time of the scanning by the scanning section 140.

Without the shields 132 and if the light from the irradiating section 130 is not reflected by the drum 110a or a recording medium P, the attenuation in intensity of the ultraviolet rays that would occur when the distance F is 70 mm or more with the shields 132 does not occur as shown in FIG. 8B. In this case, a distance F of more than 140 mm can reduce, to substantially 0%, the intensity of the ultraviolet rays that enter the CCD image sensor at the time of the scanning by the scanning section 140.

If the light from the irradiating section 130 is reflected by the drum 110a or a recording medium P, the reflected light enters the scanning section 140. Accordingly, the scanning section 140 has to be disposed at a larger distance than the distances shown in FIG. 8B.

In this embodiment, the relative positions of the irradiating section 130 and the scanning section 140 are such that the distance F between the intersection of the center line CL and the outer periphery surface of the drum 110a and the scanning position SC of the scanning section 140 is 157 mm. Such a positional relationship prevents the irradiation range on a recording medium P, which is irradiated with energy by the irradiating section 130, from overlapping the scanning position SC at which the scanning section 140 scans the recording medium P. This eliminates the influence of the energy from the irradiating section 130 on the image scanning by the scanning section 140.

The intensity of light which is emitted by the irradiating section 130 and which enters the scanning section 140 to be involved in the image scanning by the scanning section 140 is preferably measured based on the condition in which the recording medium P, conveyed by the conveying section 110, has been subjected to a treatment that reflects the light from the irradiating section 130 the most intensely among the treatments on recording media P for the image forming system 1.

Further, as to the position of the irradiating section 130 relative to the drum 110a, the irradiating section 130 is preferably as close to the drum 110a as possible only to the extent that the irradiating section 130 (e.g. the extension part 132a at the end, adjacent to the drum 110a, of each shield 132) does not block the conveyance of a recording medium P supported by the drum 110a. Such a configuration prevents energy, such as light, from reaching other components through the gap between the irradiating section 130 and the drum 110a.

The formation of a pattern image Q by the image forming section 120 will now be described.

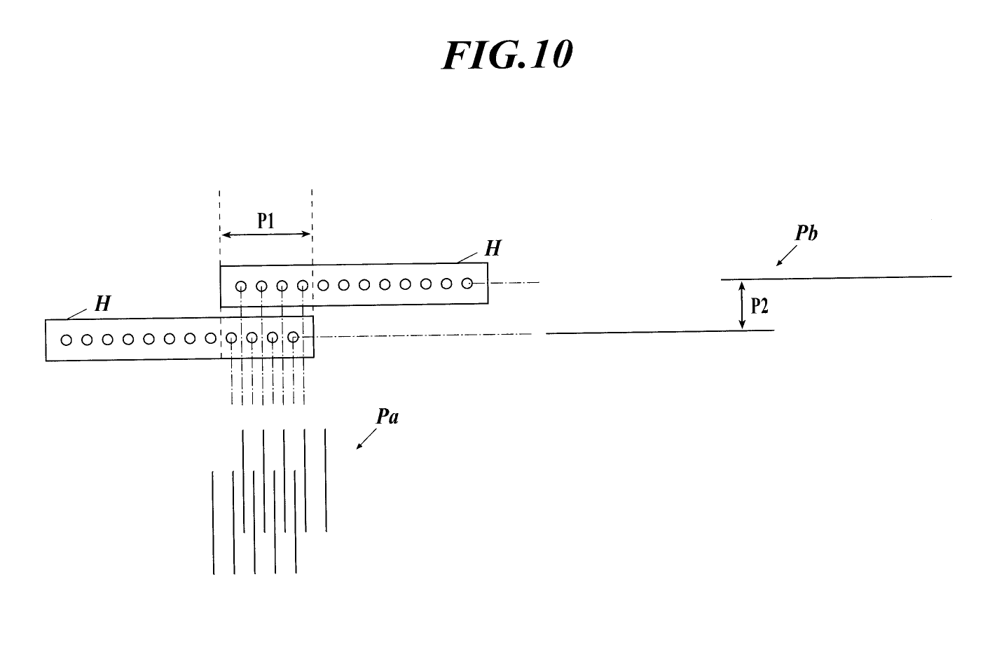

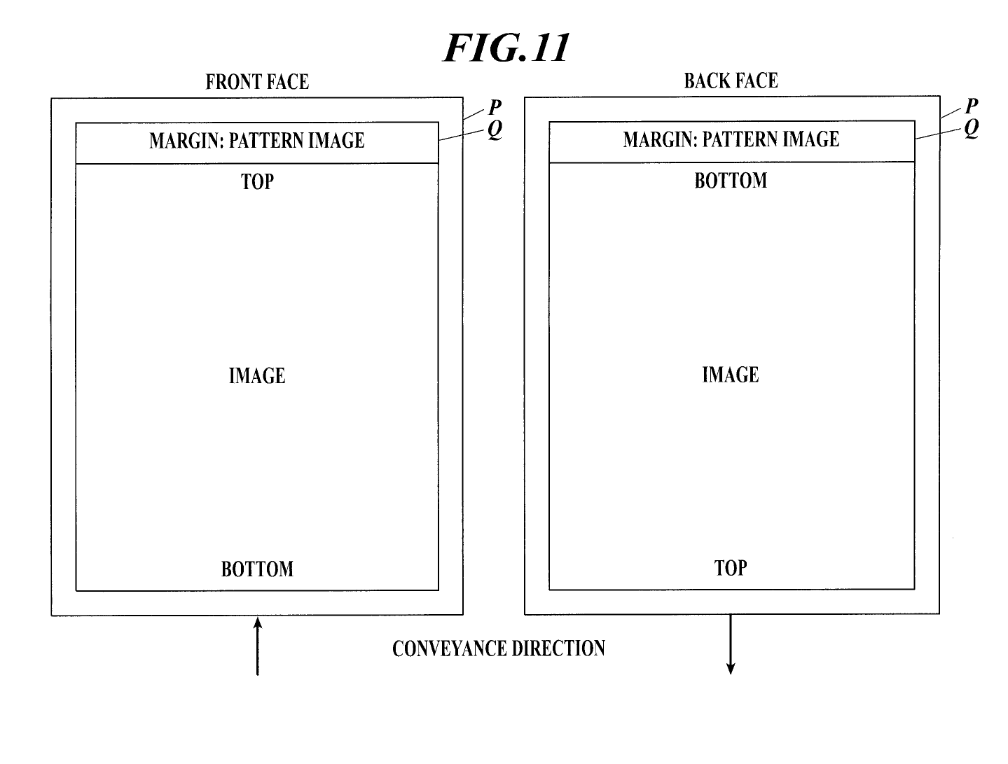

Examples of the pattern image Q include a test chart (see FIG. 9) for detection of existence of clogging of the nozzles of the recording heads H included in the head units 121, and a positional relationship adjustment image (see FIG. 10) for a check of the positional relationship between the recording heads H included in the head units 121.

The test chart is composed of, for example, lines formed with the ink discharged from the nozzles, the lines having a predetermined length in the recording medium P conveyance direction as shown in FIG. 9. The number of the lines having the predetermined length corresponds to the number of the nozzles. If there is any nozzle having clogging, abnormalities such as deficiency and fuzziness are caused relating to the formation of the line(s) corresponding to the nozzle(s) having the clogging. Existence of clogging of nozzles can thus be detected based on the test chart.

The positional relationship adjustment image is composed of, for example, a plurality of lines formed by a plurality of nozzles disposed at least in a part of the nozzle planes of a plurality of recording heads H, the part being a part where the nozzle planes overlap each other in the recording medium P conveyance direction (e.g. an overlapping part P1 in FIG. 10) as shown in FIG. 10 as the patterns Pa and Pb.

The pattern Pa is composed of a plurality of lines formed along the recording medium P conveyance direction by the nozzles that are on different recording heads H and that are in the overlapping part P1. The positional relationship between the lines indicates the positional relationship between the recording heads H, overlapping at the overlapping part P1, in the direction perpendicular to the recording medium P conveyance direction (i.e., in the width direction).

The pattern Pb is composed of a plurality of lines formed by the nozzles on different recording heads H. The interval P2 between the lines indicates the positional relationship between the recording heads H, overlapping at the overlapping part P1, in the recording medium P conveyance direction. The positional relationship between the recording heads H can be checked based on the positional relationship adjustment image.

The recording heads H in FIG. 10 are shown merely for the purpose of explaining the relation between the recording heads H and the lines constituting the patterns Pa and Pb. Actually, the positional relationship adjustment image does not include the images of the recording heads H.

The formation of a pattern image Q on each face of a recording medium P will now be described.

When a pattern image Q is to be formed on each face of a recording medium P, the control section 250 controls the image forming section 120 to form a pattern image Q on the margin at one of the ends of the recording medium P in the conveyance direction of the conveying section 110.

Specifically, the control section 250 controls the positional relationship between an image and a pattern image Q in such a way that the pattern image Q is formed on the margin at one end on each face of the recording medium P conveyed by the switchback section 115 with a switchback. So, as shown in FIG. 11, the pattern image Q is, for example, formed on the downstream end in the conveyance direction in the image formation on one face (front face) of the recording medium P, and is formed on the upstream end in the conveyance direction in the image formation on the other face (back face) of the recording medium P. The control section 250 may, of course, control the positional relationship between the image and the pattern image Q in such away that the pattern image Q is formed at the end opposite to the example shown in FIG. 11 on each face.

With respect to the control of the positional relationship between an image and a pattern image Q, in the case in which an image (e.g. the image corresponding to the image data included in a print job) is formed on each face of a recording medium P and a pattern image Q is also formed on each face of the recording medium P, the creating section 230 creates composite image data for each face. In the composite image data, the positional relationship between the image and the pattern image Q is adjusted in such a way that the pattern image Q is formed on the margin at one end.

Specifically, for example, as shown in FIG. 12, the creating section 230 stores the image data included in a print job and the image data corresponding to the pattern image Q in the individual memory areas. The creating section 230 creates composite image data for the image to be formed one face (front face) of the recording medium P, among the images corresponding to the image data included in the print job, in which composite image data the pattern image Q is connected to one end of the image (for example, the upper side in FIG. 12). Further, the creating section 230 creates composite image data for the image to be formed on the other face (back face) of the recording medium P, among the images corresponding to the image data included in the print job, in which composite image data the pattern image Q is connected to the other end of the image (for example, the lower side in FIG. 12). The one end and the other end, at which the pattern images Q are connected, correspond to the ends, in the recording medium P conveyance direction, of the image when the image is formed on the recording medium P.

The upper side in FIG. 12 corresponds to the downstream side of the image formed on the recording medium P that is conveyed. Accordingly, as to one face (front face) of the recording medium P, the pattern image Q is formed at one end to be disposed on the downstream side in the conveyance direction; whereas, as to the other face (back face) of the recording medium P, the pattern image Q is formed at one end to be disposed on the upstream side in the conveyance direction.

The control section 250 controls the operation of the image forming section 120 to form an image and a pattern image Q on each face of a recording medium P using the composite image data created by the creating section 230.

The control section 250 controls the timing of image formation by the image forming section 120 and the timing of conveyance of the recording medium P by the conveying section 110 in such a way that the pattern image Q formation areas in the conveyance direction on both faces coincide with each other as shown in FIG. 11.

Another image to be used for the adjustment of the image forming section 120 will now be described.

The image forming system 1 in this embodiment can form an image to be used for the adjustment of the image forming section 120 using an image formation area (for example, the area where the image corresponding to the image data is to be formed) on the recording surface of a recording medium P, instead of using margins.

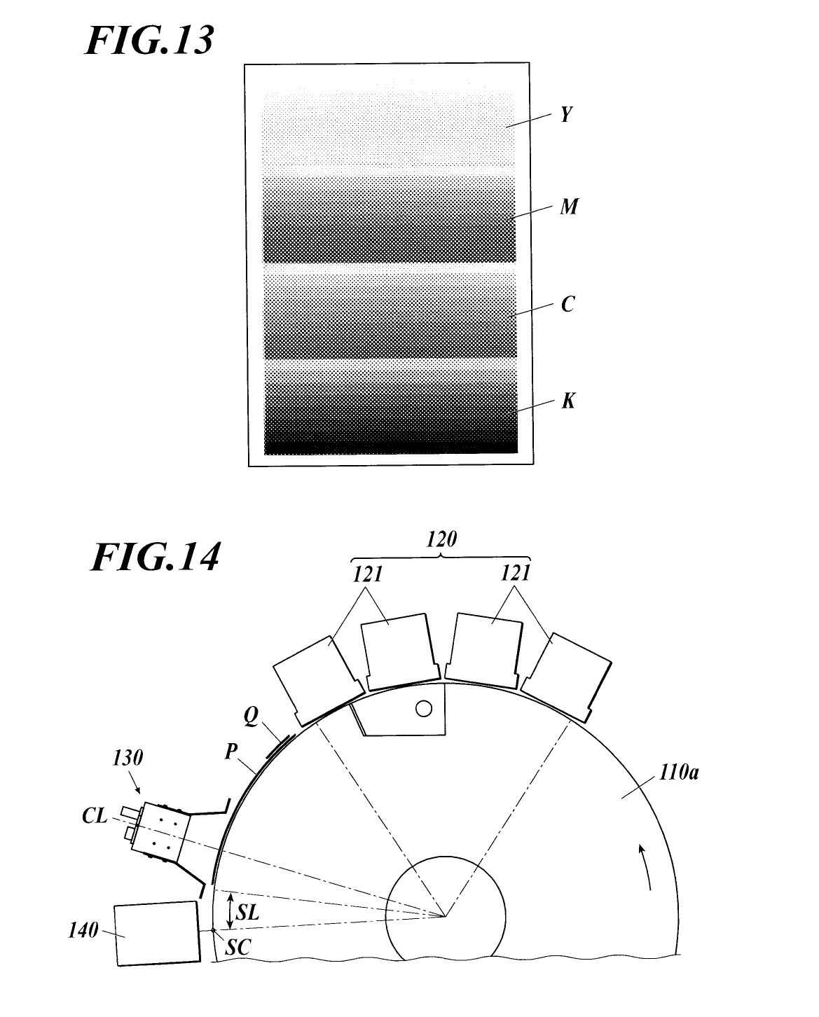

Specifically, for example, the image forming system 1 forms shading images (see FIG. 13) on a recording medium P. The shading images are images for a check of the reproducibility of the shades of the colors (e.g. four colors of CMYK) dealt with by the image forming section 120.

The shading images are formed by increasing or decreasing the amount of ink discharged from the nozzles of the head units 121 in a stepwise fashion in the recording medium P conveyance direction. The shading images allow a check of the reproducibility of the shades of the colors according to the amount of the ink discharged onto a recording medium P.

A shading image is formed individually for each of the colors dealt with by the image forming section 120 as shown in FIG. 13. In the example shown in FIG. 13, the shading images of yellow (Y), magenta (M), cyan (C), and black (K) are indicated by the initials representing the respective colors. The concrete mode, such as the positional relationship, of the shading images of the colors on a recording medium P is not limited to the above but may be modified as appropriate.

The image forming system 1, of course, can form the above-described pattern image Q in an image formation area, which is not limited to a margin, of the recording surface of a recording medium P as appropriate.

The images to be used for the adjustment of the image forming section 120 (e.g. the pattern image Q, such as the test chart and the positional relationship adjustment image, and the shading images as described above) are scanned by the scanning section 140. The control section 250 performs various operations relating to the adjustment of the image forming section 120 based on the result of the scanning by the scanning section 140. Examples of the various operations include a change in condition by the changing section 240, a temporary stop of the image formation by the image forming section 120, and the processing for notification to users.

In scanning the test chart, among the pattern images Q in the above-described examples, a resolution at which the existence or non-existence of deficient and fuzzy lines can be checked is enough. In scanning the shading images, the resolution at which the shades of colors can be checked is enough.

On the other hand, among the pattern images Q in the above-described examples, the positional relationship adjustment image requires scanning at a higher resolution than the test chart and the shading images because of the necessity for high accurate adjustment of the positional relationship between the recording heads H.

In this way, the images to be scanned by the scanning section 140 include images, such as the test chart and the shading images, which require scanning at only a relatively low resolution (low-resolution scanning images); and include images which require scanning at a relatively high resolution (high-resolution scanning image).

The control relating to the operation of the conveying section 110 at the time of the scanning by the scanning section 140 will now be described.

The resolution at which the scanning section 140 can perform scanning depends on the performance of the scanning section 140 and the relative movement speeds of the scanning section 140 and a recording medium P. Specifically, in the case of this embodiment, the performance ensured as the performance of the scanning section 140 is the performance that achieves a resolution at which a low-resolution scanning image can be properly scanned when the scanning is performed at a resolution at which the low-resolution scanning image can be scanned (first resolution) while a recording medium P is conveyed at the conveyance speed of when the image forming section 120 performs image formation (first conveyance speed).

The grounds for the performance of the scanning section 140 are as follows. If problems relating to image formation, such as clogging of nozzles, are found based on the result of scanning of a test chart formed along with an image on one face (front face) of a recording medium P at the time of both-face printing, it is preferable that the changing section 240 change the condition relating to image formation for the other face (back face).

If image formation is performed without noticing the problems, such as clogging of nozzles, the problems may lead to images with a poor image quality not only on one face but also on the other face (back face). This is not preferable in terms of prevention of the wastes of recording media P and ink. A change in condition relating to image formation for the other face (back face) can prevent the wastes of recording media P and ink that would be caused by the problems.

In order to achieve this, the performance that achieves a resolution at which the low-resolution scanning image, such as a test chart, can be scanned properly at the first conveyance speed is ensured as the performance of the scanning section 140.

Such a performance of the scanning section 140, however, cannot achieve a resolution (second resolution) required for the scanning of a high-resolution scanning image by scanning a pattern image Q formed on a recording medium P conveyed at the first conveyance speed. That is because a scanning section 140 that can scan, at the second resolution, a recording medium P conveyed at the first conveyance speed costs much and thus it is difficult to use such a scanning section 140 in this embodiment.

Hence, in order to perform scanning at the second resolution, the recording medium P conveyance speed of the conveying section 110 needs to be slowed down to a conveyance speed that is slower than the first conveyance speed (i.e., to a second conveyance speed).

The control section 250 controls the conveyance speed of the conveying section 110 based on the relationship between the performance of the scanning section 140 as described above and the conveyance speed.

If scanning at the second resolution higher than the first resolution is required and if the image forming section 120 is not performing image formation, the control section 250 sets the recording medium P conveyance speed of the conveying section 110 to a second conveyance speed slower than a first conveyance speed, the first conveyance speed being the speed of the recording medium P at which the image forming section 120 performs image formation on the recording medium P, the first resolution being a resolution at which the scanning section 140 can perform scanning while the recording medium P is conveyed at the first speed.

Specifically, for example, if a pattern image Q that needs to be scanned at the second resolution is formed on a recording medium P, the control section 250 controls the conveying section 110 to convey the recording medium P at the second conveyance speed after the completion of the formation of the pattern image Q.

Explanations are given with a more concrete example. In conveyance of a recording medium P at the first conveyance speed, at which the image forming section 120 forms, on the recording medium P, a pattern image Q that needs to be scanned at the second resolution, the control section 250 sets the recording medium P conveyance speed to the second conveyance speed after the completion of the formation of the pattern image Q and by the time the recording medium P reaches the scanning position SC if the image forming section 120 completes the formation of the image including the pattern image Q before the downstream end, of the ends in the conveyance direction, of the pattern image Q reaches the scanning position SC of the scanning section 140. This concrete example will now be described with reference to FIG. 14.

In this embodiment, as shown in FIG. 14, a slowdown area SL is provided between the most downstream position of where the image forming section 120 performs image formation on a recording medium P and the scanning position SC of the scanning section 140, on the conveyance path on which a recording medium P is to be conveyed by being supported by the drum 110a as shown in FIG. 14. The slowdown area SL is an area for reducing the conveyance speed of a recording medium P, which has been conveyed at the first conveyance speed, to the second conveyance speed. The slowdown area SL is, for example, an area within the rotation angle range of the drum 110a defined by the straight line connecting the downstream end position of the predetermined irradiation area A and the center of rotation of the drum 110a and the straight line extending from the scanning position SC of the scanning section 140 to the center of rotation of the drum 110a. This is, however, illustrative only but not limitative.

For example, if the formation of an image (including a high-resolution scanning image as a pattern image Q) on a recording medium P has been completed by the time the downstream end of the recording medium P supported and conveyed by the drum 110a reaches the upstream end of the slowdown area SL, then the formation of the pattern image Q has been completed before the downstream end, of the ends in the conveyance direction, of the pattern image Q formed on the recording medium P reaches the scanning position SC of the scanning section 140. In this case, the control section 250 reduces the rotation speed of the drum 110a during the rotation by the time the downstream end of the recording medium P passes the slowdown area SL and reaches the scanning position SC of the scanning section 140. The control section 250 thereby reduces the conveyance speed of the recording medium P, which has been conveyed at the first conveyance speed during the image formation, to the second conveyance speed. The control section 250 then operates the scanning section 140 to control the scanning section 140 to scan, at the second resolution, the high-resolution scanning image on the recording medium P that is being conveyed at the second conveyance speed.

The control section 250 obtains, for example, the positional relationship between a recording medium P supported by the drum 110a, the image forming section 120, the irradiating section 130, and the scanning section 140 based on the detection result obtained by the detector 110b, to control the conveyance speed. This is, however, illustrative only but not limitative. For example, the control section 250 obtains the positional information indicating to which part, on the upstream side, of a recording medium P the formation of an image including a pattern image Q has continued based on the image data, such as composite image data, including the pattern image Q. The control section 250 obtains the positional information of the recording medium P detected by the detector 110b. The control section 250 may then determine, based on these pieces of positional information, whether the image formation is continuing at the time when the downstream end of the pattern image Q formed on the recording medium P that is being conveyed reaches the upstream end of the slowdown area SL. If the formation of the image including the pattern image Q by the image forming section 120 is completed before the downstream end, of the ends in the conveyance direction, of the pattern image Q reaches the upstream end of the slowdown area SL, the control section 250 may set the recording medium P conveyance speed to the second conveyance speed after the completion of the formation of the image including the pattern image Q by the image forming section 120 and by the time the recording medium P reaches the scanning position SC.

If the image forming section 120 has formed, on a recording medium P, a pattern image Q that needs to be scanned at the second resolution, the control section 250 may control the conveying section 110 to convey, at the second conveyance speed, the recording medium P which has been conveyed to the upstream of the scanning section 140 by the reconveying section (e.g. the switchback section 115).

For example, in the case of image formation on one face (front face) where a pattern image Q is to be formed on the downstream side in the conveyance direction of a recording medium P, the image formation on the recording medium P may be continuing at the time when the downstream end of the recording medium P passes the slowdown area SL and reaches the scanning position SC of the scanning section 140. So, if the pattern image Q is a high-resolution scanning image, the conveyance speed has to be reduced for the pattern image Q to be scanned. The reduction in the conveyance speed during the image formation, however, has an influence on the image quality due to, for example, changes in ink discharge positions. When the conveyance speed reduction for the scanning section 140's scanning cannot be performed during the conveyance involving image formation as in this case, the control section 250 completes the image formation without reducing the conveyance speed during the image formation. At this time, the scanning section 140 does not operate. After that, the control section 250 operates the switchback section 115 to reconvey the recording medium P having an image formed thereon. Specifically, the control section 250 controls the switchback section 115 to invert the recording medium P twice. The recording medium P whose one face (front face), where a pattern image Q has been formed on the upstream part in the conveyance direction, has been facing the scanning section 140 is turned over by the first inversion and is further turned over by the second inversion. The recording medium P is thereby supported by the drum 110a with the one face (front face) of the recording medium P facing the scanning section 140 again. At the same time, the inversions by the switchback section 115 convey the recording medium P to the upstream of the scanning section 140. After the two inversions of the recording medium P by the switchback section 115, the control section 250 sets the recording medium P conveyance speed to the second conveyance speed and operates the scanning section 140 to control the scanning section 140 to scan, at the second resolution, the high-resolution scanning image formed on the recording medium P that is being conveyed at the second conveyance speed.

In the case of formation of an image that needs to be scanned at the second resolution, which is not limited to the pattern image Q as the high-resolution scanning image, if image formation on a recording medium P is continuing at the time when the downstream end of the recording medium P passes the slowdown area SL and reaches the scanning position SC of the scanning section 140, the control section 250 controls the conveying section 110 to convey, at the second conveyance speed, the recording medium P that has been conveyed to the upstream of the scanning section 140 by the reconveying section (e.g. the switchback section 115).

When a recording medium P is conveyed at the second conveyance speed, the control section 250 decreases the amount of the energy per unit time to be emitted by the irradiating section 130 compared to when a recording medium P is conveyed at the first conveyance speed.

Specifically, when a recording medium P is conveyed at the second conveyance speed and there is a need for energy irradiation by the irradiating section 130, the control section 250 decreases the amount of the energy per unit time to be emitted by the irradiating section 130 compared to when a recording medium P is conveyed at the first conveyance speed, in such a way that the total amount of energy (e.g. total amount of light) per unit area on the recording medium P conveyed at the second conveyance speed equals the total amount of energy per unit area on the recording medium P conveyed at the first conveyance speed.

More specifically, as shown in FIG. 14, for example, even when the image formation by the image forming section 120 has been completed and the reduction in the recording medium P conveyance speed in the slowdown area SL does not have an influence on the image quality which would be caused by changes in ink discharge positions, the energy irradiation to the image that has been formed on the recording medium P may have yet to be completed at the time when the downstream end of the recording medium P reaches the scanning position SC of the scanning section 140. In such a case, if the quantity of the energy irradiation by the irradiating section 130 is the same as that for the first conveyance speed, the total amount of energy for the image passing the predetermined irradiation area A after the reduction to the second conveyance speed is larger than that for the image passing the predetermined irradiation area A at the first conveyance speed. In view of this, the control section 250 decreases the amount of the energy per unit time to be emitted by the irradiating section 130 compared to when a recording medium P is conveyed at the first conveyance speed. The specific level of the decrease depends on, for example, the ratio of the first conveyance speed to the second conveyance speed.

The control section 250 may stop the irradiating section 130 from operating if a recording medium P is conveyed at the second conveyance speed. For example, if the reconveying section (e.g. the switchback section 115) conveys a recording medium P to the upstream of the scanning section 140 and the scanning section 140 scans, at the second resolution, the recording medium P that is being conveyed by the conveying section 110 at the second conveyance speed, the image formation on the recording medium P conveyed to the upstream of the scanning section 140 has already been completed. In this case, the irradiating section 130 does not have to perform energy irradiation again to the recording medium P on which the image formation has already been completed. So, the control section 250 stops the operation of the irradiating section 130 so that the amount of the energy per unit time to be emitted by the irradiating section 130 is zero.

If a pattern image Q that can be acceptably scanned at the first resolution has been formed on a recording medium P, the control section 250 controls the conveying section 110 to continue the conveyance of the recording medium P at the first conveyance speed, which conveyance has been performed for the formation of the pattern image Q.

Specifically, for example, if scanning of a recording medium P conveyed at the first conveyance speed can achieve a resolution good enough for an intended use as in the case of scanning of a low-resolution scanning image by the scanning section 140, the conveyance at the first conveyance speed can be continued regardless of whether the image formation is being performed at the time when the low-resolution scanning image reaches the scanning position SC of the scanning section 140. Hence, the control section 250 controls the conveying section 110 to continue the conveyance of the recording medium P at the first conveyance speed, which conveyance has been performed for the formation of the low-resolution scanning image, to allow the recording medium P having the low-resolution scanning image formed thereon to pass the scanning position SC of the scanning section 140.

In the case of scanning of an image that can be acceptably scanned at the first resolution, which is not limited to the pattern image Q as the low-resolution scanning image but includes shading images, the control section 250 controls the conveying section 110 to continue the conveyance of a recording medium P at the first conveyance speed, which conveyance has been performed for the formation of the low-resolution scanning image, to allow the recording medium P having the image formed thereon to pass by the scanning section 140.

The image forming system 1 in this embodiment includes the inverting section (e.g. the switchback section 115) and the scanning section 140 that is disposed downstream of the image forming section 120 and upstream of the inverting section in the conveyance direction. The operation of the both-face conveyance mechanism allows the scanning section 140 to scan both faces of a recording medium P. The scanning of both faces of a recording medium P can thus be performed at low cost without introducing scanning sections 140 for scanning respective faces individually.

Since the system includes the changing section 240 to change the condition relating to image formation by the image forming section 120 based on the result of scanning by the scanning section 140, the condition can be changed if the result of scanning by the scanning section 140 indicates some events due to which image formation should not be continued without changing the condition (e.g. clogging of nozzles). In this way the system can perform the operation control in image formation in accordance with such events. This can prevent various wastes (e.g. wastes of recording media P and ink and waste of time spent for image formation under improper conditions) that would be caused by image formation performed under improper conditions.

The condition to be changed by the changing section 240 includes the condition relating to ink discharge from the nozzles. So, the condition can be changed if the result of scanning by the scanning section 140 indicates some events due to which image formation should not be continued without changing the condition relating to ink discharge from the nozzles (e.g. clogging of nozzles), and thus the operation control in image formation can be performed in accordance with such events. This can prevent various wastes, such as waste of ink, which would be caused by image formation performed under improper conditions.

The scanning section 140, which is disposed downstream of the irradiating section 130 (fixing section), can scan the image that has been fixed by the irradiating section 130 and that will not change any more. Thus the obtained result of scanning of the image is equivalent to the image visually recognized by a user.

Further, the relative positions of the irradiating section 130 and the scanning section 140 are such that the irradiation range on a recording medium P, which is irradiated with energy by the irradiating section 130, does not overlap the scanning position SC at which the scanning section 140 scans the recording medium P. So, the scanning section 140 can properly perform scanning even if the irradiating section 130 is operating at the time of the scanning operation by the scanning section 140. That is, the image forming system 1 in this embodiment can reduce the influence of the energy emitted by the irradiating section 130 to a recording medium P on the result of scanning by the scanning section 140.

Further, the shields 132 which block a part of the energy from the irradiating section 130 between the irradiating section 130 and the scanning section 140 can limit the range where the energy from the irradiating section 130 reaches. The shields 132 thus make it easy to dispose the irradiating section 130 and the scanning section 140 at such relative positions that the irradiation range on a recording medium P, which is irradiated with energy by the irradiating section 130, does not overlap the scanning position SC at which the scanning section 140 scans the recording medium P.

Further, the shields 132 allow the irradiating section 130 and the scanning section 140 to be disposed close to each other, leading to reduction in size of the image forming device (main body unit 100).

The relative positions of the irradiating section 130 and the scanning section 140 are such that the intensity of the light which is emitted by the irradiating section 130 and which enters the scanning position SC to be involved in the image scanning by the scanning section 140 is equal to or less than the intensity of light required for the detection of difference in gradation of an image scanned by the scanning section 140. Accordingly, the energy that has been attenuated by the shields 132 does not have an influence on the image scanning by the scanning section 140 even if it is difficult to physically completely separate the irradiating section 130 and the scanning section 140, both of which are disposed to face a recording medium P being conveyed by the conveying section 110, and even if a part of the energy emitted by the irradiating section 130 reaches the scanning position SC of the scanning section 140.

If a pattern image Q is to be formed on each face of a recording medium P, the control section 250 controls the image forming section 120 to form each pattern image Q on the margin at one of the ends of the recording medium P in the conveyance direction of the conveying section 110. Accordingly, the other end area on each face can be used for formation of an image. That is, in forming an image and a pattern image Q on each face of a recording medium P, a larger area can be used for formation of the image.

If both an image and a pattern image Q are to be formed on each face of a recording medium P, the creating section 230 creates the composite image data for each face, in which composite image data the positional relationship between the image and the pattern image Q is adjusted in such a way that the pattern image Q is formed on the margin at one end. The control section 250 can form the pattern image Q on the margin at one end on each face of the recording medium P merely by forming the image and the pattern image Q on each face of the recording medium P using the composite image data created by the creating section 230. The processing relating to the positional relationship between the image and the pattern image Q for each face can thus be simplified.

The control section 250 controls the image formation timing of the image forming section 120 and the recording medium P conveyance timing of the conveying section 110 in such a way that pattern image Q formation areas on both faces coincide with each other in the conveyance direction. That is, the control section 250 allows the areas for the pattern images Q on both faces to coincide with each other in the conveyance direction. So, the same area on both faces can be used for formation of the image other than the pattern image Q (i.e., the image corresponding to the image data), in the area on a recording medium P on which the image forming section 120 can perform image formation. That is, a larger area can be used for formation of the image.

If scanning needs to be performed at a second resolution higher than a first resolution and image formation is not being performed by the image forming section 120, the control section 250 sets the recording medium P conveyance speed of the conveying section 110 to a second conveyance speed slower than a first conveyance speed. This can reduce the recording medium P conveyance speed relative to the scanning section 140 at the time of scanning without deteriorating the image quality. That is, both the first resolution and the second resolution can be achieved by controlling the conveyance speed according to an expected resolution, and at the same time good image quality can be achieved.

If a pattern image Q that needs to be scanned at the second resolution has been formed on a recording medium P by the image forming section 120, the control section 250 controls the conveying section 110 to convey the recording medium P at the second conveyance speed after the completion of the formation of the pattern image Q. Thus the recording medium P conveyance speed relative to the scanning section 140 can be reduced at the time of the image scanning without disrupting the formation of the pattern image Q. This achieves both the control of the conveyance speed for scanning of the pattern image Q that needs to be scanned at the second resolution and proper formation of the pattern image Q.

In the conveyance of a recording medium P at the first conveyance speed, at which the image forming section 120 forms, on the recording medium P, a pattern image Q that needs to be scanned at the second resolution, if the formation of the image including the pattern image Q by the image forming section 120 is completed before the downstream end, of the ends in the conveyance direction, of the pattern image Q reaches the scanning position SC of the scanning section 140, the control section 250 sets the recording medium P conveyance speed to the second conveyance speed after the completion of the formation of the pattern image Q and by the time the recording medium P reaches the scanning position SC. Accordingly, the scanning of the pattern image Q can be performed without reconveying the recording medium P using the configuration for the reconveyance, such as the switchback section 115, in association with the conveyance for the image formation. Thus, the image formation including the formation of the pattern image Q as well as the scanning of the pattern image Q can be performed with a short conveyance path.

If a pattern image Q that needs to be scanned at the second resolution has been formed on a recording medium P by the image forming section 120, the control section 250 controls the conveying section 110 to convey, at the second conveyance speed, the recording medium P that has been conveyed by the reconveying section (e.g. the switchback section 115) to the upstream of the scanning section 140. Accordingly, the pattern image Q can be scanned at the second resolution even if the conveyance speed cannot be set to the second conveyance speed during the image formation including the formation of the pattern image Q that needs to be scanned at the second resolution.

If a pattern image Q that can be acceptably scanned at the first resolution has been formed on a recording medium P, the control section 250 controls the conveying section 110 to continue the conveyance of the recording medium P at the first conveyance speed, which conveyance has been performed for the formation of the pattern image Q. Accordingly, the scanning of the pattern image Q can be performed without reconveying the recording medium P using the configuration for the reconveyance, such as the switchback section 115, in association with the conveyance for the image formation. Thus, the image formation including the formation of the pattern image Q as well as the scanning of the pattern image Q can be performed with a short conveyance path.

If a recording medium P is conveyed at the second conveyance speed, the control section 250 decreases the amount of the energy per unit time to be emitted by the irradiating section 130 compared to when a recording medium P is conveyed at the first conveyance speed. Accordingly, the total amount of energy (e.g. total amount of light) per unit area on the recording medium P conveyed at the second conveyance speed is equal to the total amount of energy per unit area on the recording medium P conveyed at the first conveyance speed. Thus, the image fixed on the recording medium P has uniform image quality regardless of the conveyance speed.

If a recording medium P is conveyed at the second conveyance speed, the control section 250 does not operate the irradiating section 130. This prevents waste of energy that would be caused if the irradiating section 130 is operated while a recording medium P is conveyed with no operation of the image forming section 120. Further, changes in recording media P and changes in the images formed on the recording media P due to unnecessary energy irradiation can be prevented.

The image forming section 120, the irradiating section 130, and the scanning section 140 can be disposed in such away that the distances between the image forming section 120 and the irradiating section 130 and the scanning section 140 are short without affecting the result of scanning. Accordingly, the changing section 240 can quickly change in condition relating to image formation by the image forming section 120. Thus, various wastes, such as waste of ink, which would be caused by image formation performed under improper conditions, can be prevented.

The embodiment of the present invention described above should not be construed as limitative but should be construed as illustrative only in all respects. The scope of the present invention is defined not by the description given above but by the claims, and it is intended that the present invention includes all the modifications within the meaning and scope equivalent to the claims.

For example, the control section 250 may control the formation positions of pattern images Q on a recording medium P in such a way that the formation positions of the pattern images Q for both faces do not coincide with each other.

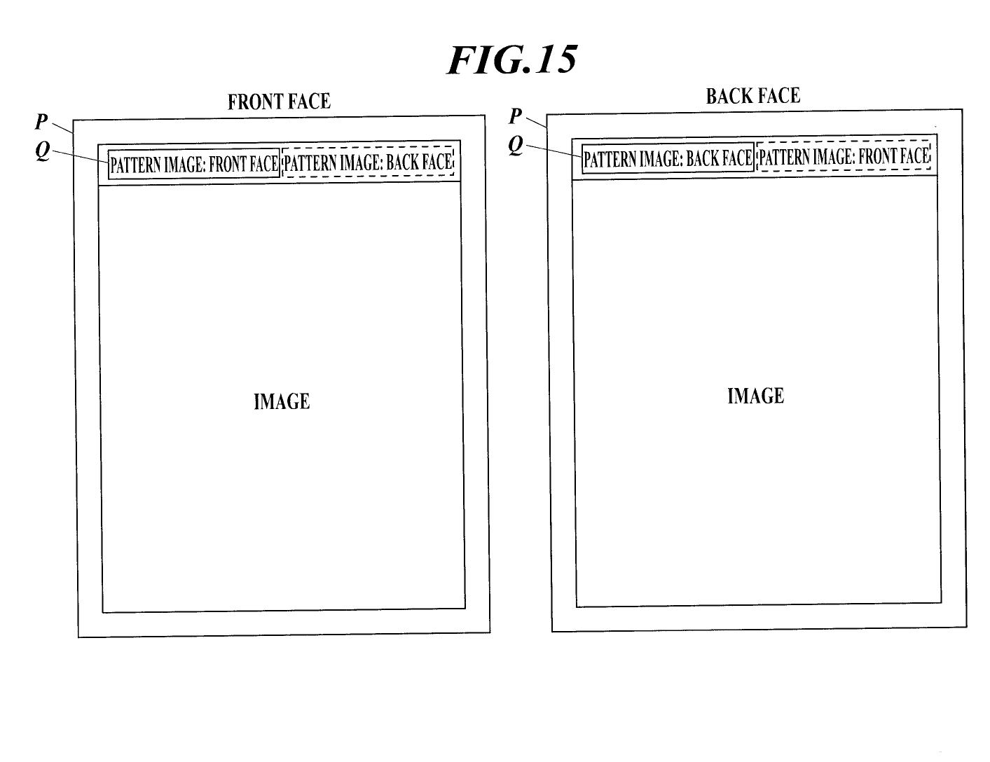

Specifically, for example, as shown in FIG. 15, an area for a pattern image Q on one face (front face) and an area for a pattern image Q on the other face (back face) may be at different positions in the width direction of a recording medium P. The control on the areas of the pattern images Q may be performed for a pattern image Q that fits within a half or less of the maximum breadth of an image formation area with respect to the width direction of a recording medium P. Concrete examples include a test chart formed by a non-single-pass inkjet recording device with an image forming section 120 including head units 121 that move back and forth in the width direction.

The control section 250 may control the operation relating to pattern image Q formation in such a way that a pattern image Q is formed on only one face and is not formed on the other face (for example, in the case in which formation of pattern images Q at different positions is impossible).

Specifically, for example, if a recording medium P is of a type such that an image formed on one face (front face) can be seen through from the other face (back face), the pattern images Q formed at one end and superposed on each other may yield incorrect result of scanning of the pattern image Q formed on the other face. In such a case, the control section 250 may form a pattern image Q only on one face without forming a pattern image Q on the other face.

In the embodiment described above, the creating section 230 in the main body unit 100 creates composite image data. This is, however, illustrative only but not limitative. For example, an information processing device connected to the image forming system 1, such as a PC shown in FIG. 2, may create composite image data for each face of a recording medium P for forming both an image and a pattern image Q on each face of the recording medium P, in which composite image data the positional relationship between the image and the pattern image Q is adjusted in such a way that the pattern image Q is formed on the margin at one end; and may output the created composite image data to the image forming device. The control section 250 of the image forming system 1 may then form the image and the pattern image Q on each face of the recording medium P using the composite image data output from the information processing device.

The composite image data created by the information processing device connected to the image forming system 1 may include a blank part corresponding to an amount of conveyance to adjust the image formation timing of the image forming section 120 in such a way that the pattern image Q formation areas on both faces coincide with each other in the conveyance direction.

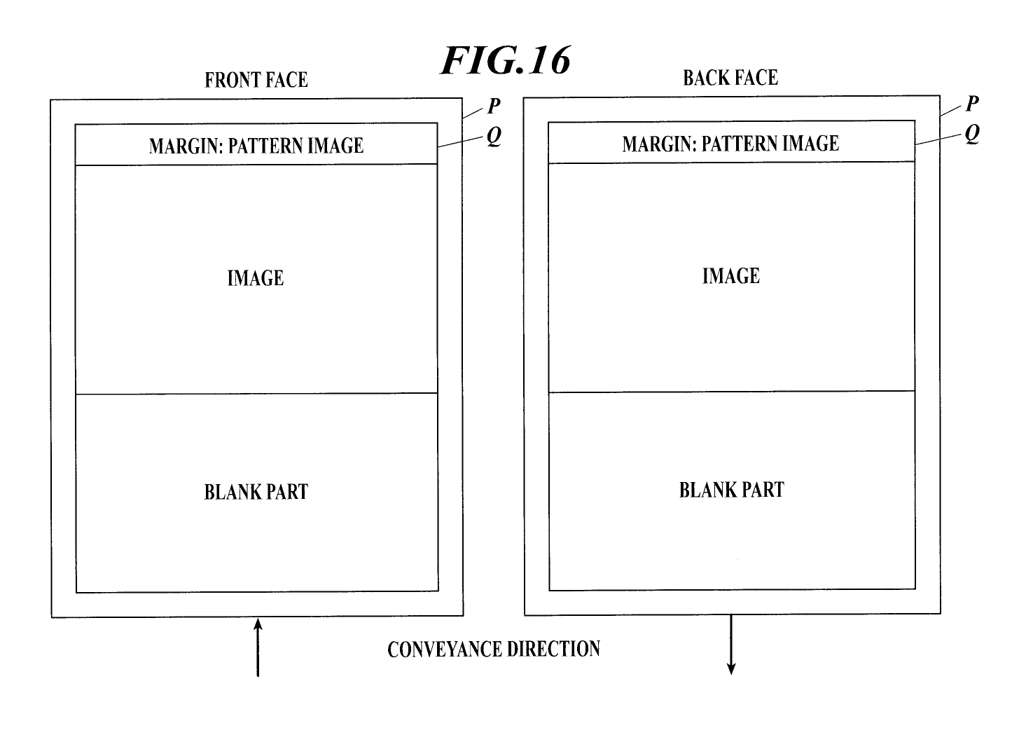

Specifically, for example, as shown in FIG. 16, the composite image data may include a pattern image Q disposed in such a way that the pattern image Q is formed at one end, an image other than the pattern image Q (i.e., the image corresponding to the image data to be formed on each face), and a blank part corresponding to the area other than the areas for formation of the pattern image Q and the image other than the pattern image Q in the maximal area on which the image forming section 120 can perform image formation in one face of a recording medium P. As shown in FIG. 16, the pattern images Q in the composite image data are adjusted in such a way that the pattern image Q formation areas on both faces coincide with each other in the conveyance direction.

Since the information processing device creates the composite image data for each face and outputs the composite image data to the image forming device, the control section 250 can form the pattern image Q at one end of a recording medium P on each face of the recording medium P without performing special control relating to the position of the pattern image Q.

Since the composite image data created by the information processing device connected to the image forming system 1 includes a blank part corresponding to an amount of conveyance to adjust the image formation timing of the image forming section 120 in such a way that the pattern image Q formation areas on both faces coincide with each other in the conveyance direction, the areas for the pattern images Q on both faces can easily coincide with each other in the conveyance direction. So, the same area on both faces can be used for formation of the image other than the pattern image Q (i.e., the image corresponding to the image data), in the area on a recording medium P on which the image forming section 120 can perform image formation. That is, a larger area can be used for formation of the image.

In an example shown in FIG. 16, the blank part is disposed at the other end on each face. This is, however, illustrative only but not limitative. For example, the blank part may be disposed between the margin, on which the pattern image Q is formed, and the area, on which the image corresponding to the image data is formed; or may be disposed in a part or a whole of the area around the image corresponding to the image data.

In the embodiment described above, the scanning section 140 scans pattern images Q and shading images. This is, however, illustrative only but not limitative. The scanning section 140 may scan any image that is formed on a medium conveyable by the conveying section 110.

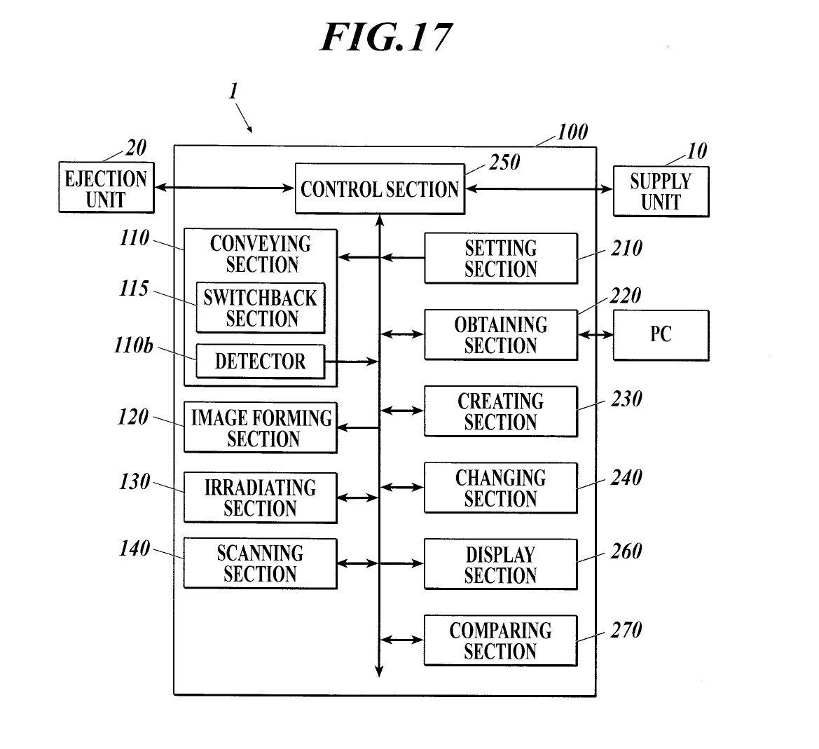

As shown in FIG. 17, the main body unit 100 of the image forming system 1 may include a comparing section 270 which compares the image data, based on which an image is to be formed by the image forming section 120, with the scanning data created by the scanning section 140's scanning the image formed by the image forming section 120 based on the image data. In this case, the changing section 240 may change the condition based on the comparison result obtained by the comparing section 270.

The condition relating to image formation to be changed by the changing section 240 is not limited to the condition relating to ink discharge from the nozzles.

For example, the condition may include a content relating to the brightness of an image.

For example, the changing section 240 may change the level of ink discharge which relates to reproduction of shades of colors based on the result of scanning of shading images by the scanning section 140. Further, the scanning section 140 may scan the image formed based on the image data, the comparing section 270 may perform the comparison for each of the colors (e.g. four colors of CMYK) used for image formation, and the amount of ink of each color to be discharged may be changed in such a way that the brightness of the image formed on a recording medium P is the same as the brightness in the image data.

The condition including a content relating to the brightness of an image in this way can make the brightness of the image formed on a recording medium P the same as the brightness in the image data.

The concrete contents of the condition relating to image formation to be changed by the changing section 240 are not limited to the examples shown above.

For example, if clogging is detected at a predetermined number or more of the nozzles based on the result of scanning of a test chart, the changing section 240 may change the condition relating to image formation in such a way that the image formation by the image forming section 120 is stopped. In this case, the control section 250 may control the image forming section 120 to perform a maintenance operation to eliminate the clogging of the nozzles. Concrete examples of the maintenance operation include discharge maintenance where the head units 121 are moved to a cleaning section and where the nozzles are driven in such a way that ink is forcibly discharged from the nozzles having the clogging to eliminate the clogging of the nozzles.

The comparison by the comparing section 270 is not limited to the comparison relating to image brightness.

For example, in order to check the reproducibility of an image formed on a recording medium P, the comparing section 270 may compare the pixels of image data with the pixels of the image data corresponding to the result of scanning created by the scanning section 140's scanning. If a problem in image reproducibility is found, e.g., the degree of difference in color of pixels exceeding a predetermined degree, the changing section 240 may change the condition relating to image formation to stop image formation by the image forming section 120. This can prevent further wastes of recording media P and ink that would be caused if a problem, such as appearance of white streaks that does not actually exist in the image of the image data, arose in the image formed on a recording medium P and the image formation continued without removing the problem.

The items that act as a benchmark for stopping image formation, such as the predetermined number and the predetermined degree as described above, may be arbitrarily set by a user operation through, for example, the setting section 210.

In the embodiment described above, the shields 132 extend from the sides of the case of the light source 131 toward the outer periphery surface of the drum 110a of the conveying section 110. This is, however, illustrative only but not limitative. For example, the shields 132 may be provided separately from the irradiating section 130 and the scanning section 140, for example, as a light shielding plate (s) disposed between the irradiating section 130 and the scanning section 140. Alternatively, a shield(s) 132 and the scanning section 140 may be provided as a single piece.

In the embodiment described above, the energy emitted by the irradiating section 130 is ultraviolet rays. This is, however, illustrative only but not limitative. Other examples of energy include waves, such as infrared rays (IR), other rays or electromagnetic waves that can cure ink, and heat generated by these waves. Specific energy is selected according to the characteristics of ink.

Concrete matters relating to the influence of the energy emitted by the irradiating section 130 on the scanning section 140 depend on the energy. For example, if infrared rays are used as the energy, the influence relating to the light in a wavelength of 700 nm or more is particularly considered among the lights in wavelengths to which the CCD image sensor is sensitive. The concrete structure and material of the shields 132 are determined in such a way that the shields 132 block a part of the energy from the irradiating section 130 between the irradiating section 130 and the scanning section 140.

The scanning section 140 in this embodiment based on the example shown in FIG. 6 is a CCD image sensor. This is, however, illustrative only but not limitative. The influence of the energy emitted by the irradiating section 130 depends on the characteristics of the image sensor used as the scanning section 140.

The shields 132 in the embodiment described above extend more than to a position where the shields 132 block a part of the energy from the irradiating section 130 between the irradiating section 130 and the scanning section 140, so that the range to be irradiated with the ultraviolet rays emitted by the light source 131 (i.e., irradiation range) is confined to the predetermined irradiation area A. This is, however, illustrative only but not limitative. The shields 132 extending at least to such a position as to block a part of the energy from the irradiating section 130 between the irradiating section 130 and the scanning section 140 is enough.

The image forming section 120 in the embodiment described above performs ink-jet image formation. This is, however, illustrative only but not limitative. For example, the image forming section 120 may include a primary transfer section to form an image on a photoreceptor to come into contact with a recording medium P supported by a drum 110a, and a secondary transfer section to transfer the image from the photoreceptor to the recording medium P to perform electrophotographic image formation. Alternatively, the image forming section 120 may perform image formation in another image formation method.

The control section 250 may control the conveyance of a recording medium P based on the result of scanning by the scanning section 140.

Specifically, for example, the control section 250 may control the ejection switching guide 113 in such a way that the recording media P having images determined to be poor based on the results of scanning by the scanning section 140 are ejected to the sub tray 20b and that only the recording media P having images determined to be normal are ejected to the main tray 20a. Such a control allows users to easily distinguish the recording media P having normal images formed thereon from the recording media P having images determined to be poor formed thereon.

In the case of both-face image formation, if the image recorded on the first face (front face) is determined to be abnormal, the recording medium P may be immediately ejected to the sub tray 20b through the belt loop 112 and the ejection switching guide 113 without being conveyed to the switchback section 115, and the image formation may be performed again on another recording medium P after the condition relating to image formation is changed as described above. This can prevent wastes of time and materials, such as ink, that would be consumed if wasteful recording were performed on recording media P.

If the image recorded on the first face (front face) of a recording medium P is determined to be abnormal after the recording medium P is conveyed to the switchback section 115 in the case of both-face image formation, the recording medium P may be ejected to the sub tray 20b through the drum 110a, the cylinder 111, the belt loop 112, and the ejection switching guide 113 with no image on the second face (back face) if the image formation on the second face (back face) has not been started, or the image formation on the second face (back face) may be stopped to eject the recording medium P to the sub tray 20b through the drum 110a, the cylinder 111, the belt loop 112, and the ejection switching guide 113 if the image formation on the second face (back face) has already started. This can prevent wastes of materials, such as ink, that would be consumed if wasteful recording were performed on recording media P.

In the embodiment described above, the slowdown area SL is set for the control of the conveyance speed. This is, however, illustrative only but not limitative.

For example, in the conveyance of a recording medium P at the first conveyance speed at which the image forming section 120 forms, on the recording medium P, a pattern image Q that needs to be scanned at the second resolution, if the formation of the image including the pattern image Q by the image forming section 120 is completed before the downstream end, of the ends in the conveyance direction, of the pattern image Q reaches the scanning position SC of the scanning section 140, the control section 250 may stop the conveying section 110 upon completion of the formation of the pattern image Q and then may control the conveying section 110 to convey the recording medium P at the second conveyance speed. This enables, with no slowdown area SL, the scanning section 140 to scan the recording medium P conveyed at the second conveyance speed in the conveyance process where the recording medium P is conveyed for formation of the pattern image Q on the recording medium P.

The concrete configuration of the obtaining section 220 is illustrative only but not limitative. The obtaining section 220 may include any type of interface that can connect a storage device, such as a hard disk and a flash memory card, storing the image data based on which images are to be formed on recording media P.

In the embodiment described above, the switchback section 115 inverts and reconveys sheets. This is, however, illustrative only but not limitative. Any concrete configuration may be employed as long as the sheets can be inverted and reconveyed. For example, the inversion and reconveyance may be performed using a combination of a plurality of rollers.

In the embodiment described above, a single scanning section 140 is used. This is, however, illustrative only but not limitative. For example, the main body unit 100 may include a plurality of scanning sections 140 configured to scan one face of a medium.

The concrete configuration of the embodiment of the present invention may be modified as appropriate without departing from the features of the present invention.

### INDUSTRIAL APPLICABILITY

The present invention can be applied to an image forming device.

### REFERENCE NUMERALS

1 image forming system
100 main body unit (image forming device)
110 conveying section
110a drum
115 switchback section (inverting section)
120 image forming section
130 irradiating section (fixing section)
140 scanning section
210 setting section
240 changing section
250 control section
260 display section
270 comparing section

1. An image forming device comprising:
an image forming section which includes a recording head having nozzles from which ink is to be discharged, and which forms an image on a recording medium by discharging the ink from the nozzles;
a scanning section which scans the image formed on one face of the recording medium by the image forming section;
a conveying section which conveys the recording medium in such a way that the recording medium passes by locations of the image forming section and the scanning section with one face of the recording medium facing the image forming section and the scanning section; and
an inverting section which, if the image is to be formed on each face of the recording medium by the image forming section, inverts the recording medium having the image formed on one face thereof and conveys the recording medium to an upstream of the image forming section in a conveyance direction of the conveying section,
wherein the scanning section is disposed downstream of the image forming section and upstream of the inverting section in the conveyance direction; and
wherein the image includes a test chart as a pattern image for detection of existence of clogging of the nozzles.

2. The image forming device according to claim 1, further comprising a changing section which changes a condition relating to image formation by the image forming section based on a result of scanning of the pattern image by the scanning section.

3. The image forming device according to claim 2, wherein
the condition includes a condition relating to ink discharge from the nozzles.

4. The image forming device according to claim 2, wherein
the condition includes a content relating to brightness of the image.

5. The image forming device according to claim 2, further comprising a comparing section which compares image data, based on which the pattern image is to be formed by the image forming section, with scanning data created by the scanning section's scanning the pattern image formed by the image forming section based on the image data, wherein
the changing section changes the condition based on a result of comparison by the comparing section.

6. The image forming device according to claim 1, further comprising a fixing section which fixes the image formed by the image forming section on the recording medium by curing the ink which has been discharged onto the recording medium, wherein
the scanning section is disposed downstream of the fixing section.

7. The image forming device according to claim 1, further comprising:
a setting section which makes a setting as to whether the image is to be formed on one face or each face of the recording medium by the image forming section; and
a display section which performs display relating to the setting made by the setting section.

8. The image forming device according to claim 1, further comprising a control section which controls conveyance of the recording medium based on a result of scanning of the pattern image by the scanning section.

9. The image forming device according to claim 1, wherein
the scanning section is disposed on one side of a conveyance path on which the recording medium is to be conveyed by the conveying section; and
after the scanning section scans, from the one side, the image formed on one face of the recording medium, the inverting section inverts and conveys the recording medium, the image forming section forms an image on the other face of the recording medium, and the scanning section scans, from the one side, the image formed on the other face.

10. The image forming device according to claim 3, wherein
the changing section changes the condition relating to the ink discharge from the nozzles in such a way that, if the clogging is detected at any of the nozzles of the recording head based on the result of the scanning of the pattern image by the scanning section, a missing part is covered by the ink discharged onto a neighborhood of the missing part on the recording medium, the missing part being a part onto which no ink is discharged due to the clogging of the any of the nozzles.

11. The image forming device according to claim 3, wherein
the changing section changes the condition relating to the ink discharge from the nozzles in such a way that, if the clogging is detected at a predetermined number or more of the nozzles based on the result of the scanning of the pattern image by the scanning section, the image formation by the image forming section is stopped.

12. The image forming device according to claim 1, wherein
if the clogging is detected at a predetermined number or more of the nozzles based on a result of scanning of the pattern image by the scanning section, a maintenance operation for the image forming section is performed to eliminate the clogging.

13. The image forming device according to claim 1, wherein the pattern image is formed on a margin of the recording medium on which an image corresponding to image data included in a print job is formed.

14. The image forming device according to claim 13, wherein the pattern image is formed on the margin on each face of the recording medium.

15. The image forming device according to claim 1, wherein the conveying section includes a cylindrical drum having an outer periphery surface to support the recording medium thereon to convey the recording medium.
